(19) United States
(12) Patent Application Publication
(10) Pub. No.: US 2026/0059229 A1
(43) Pub. Date: Feb. 26, 2026

(54) ACOUSTIC OUTPUT DEVICE

(71) Applicant: SHENZHEN SHOKZ CO., LTD., Shenzhen (CN)

(72) Inventors: Jianing LIANG, Shenzhen (CN); Zhen WANG, Shenzhen (CN); Lei ZHANG, Shenzhen (CN); Xin QI, Shenzhen (CN)

(73) Assignee: SHENZHEN SHOKZ CO., LTD., Shenzhen (CN)

(21) Appl. No.: 19/373,672

(22) Filed: Oct. 29, 2025

Related U.S. Application Data
(63) Continuation of application No. PCT/CN2024/095475, filed on May 27, 2024.

(51) Int. Cl. H04R 1/28; H04R 1/10; H04R 1/24; H04R 3/14

(52) U.S. Cl. CPC H04R 1/2811; H04R 1/105; H04R 1/24; H04R 3/14

(57) ABSTRACT

An acoustic output device is provided. The acoustic output device includes: a first speaker, a second speaker, a housing, and a support structure. The first speaker includes a first diaphragm configured to generate sound in a first frequency band. The second speaker includes a second diaphragm configured to generate sound in a second frequency band. The second frequency band includes frequencies higher than an upper limit frequency of the first frequency band. The housing is configured to carry the first speaker and the second speaker. The support structure is configured to place the housing near an ear canal without blocking an entrance of the ear canal. At least two sound guiding holes are disposed on the housing. A first sound guiding hole of the at least two sound guiding holes is acoustically coupled to a front side of the first diaphragm and defines a front chamber of the first speaker. A second sound guiding hole of the at least two sound guiding holes is acoustically coupled to a rear side of the first diaphragm and defines a rear chamber of the first speaker. The front chamber has a first resonance frequency. The rear chamber has a second resonance frequency. A higher one of the first resonance frequency and the second resonance frequency is in a range of 3 kHz to 6 kHz.

### CROSS REFERENCE TO RELATED APPLICATIONS

The present disclosure is a Continuation of International Application No. PCT/CN2024/095475, filed on May 27, 2024, the entire contents of which are incorporated herein by reference.

### TECHNICAL FIELD

The present disclosure relates to a field of acoustics, and in particular, to an acoustic output device that uses two speakers to generate sound in different frequency bands, respectively.

### BACKGROUND

Open acoustic output devices are increasingly widely used in daily lives of people. However, due to the open-fit nature relative to the ear, the open acoustic output devices inevitably radiate sound leakage to the surrounding environment.

To mitigate sound leakage of an acoustic output device, for sound frequency bands with relatively low frequencies, sounds with opposite phases may be output from a sound guiding hole of a front chamber and a pressure relief hole of a rear chamber of the acoustic output device. Under far-field conditions, an acoustic path difference of the sound with opposite phases reaching a certain point in the far field is substantially negligible. Therefore, the sounds can cancel each other out, thereby reducing sound leakage in the far field. However, for sound frequency bands with relatively high frequencies, due to the shorter wavelength of the sound waves and the influence of the chamber structure of the acoustic output device, the phases of the sound emitted from the sound guiding hole and the pressure relief hole are no longer opposite. This results in an unsatisfactory far-field sound leakage reduction and may even cause interference between the sound emitted from the sound guiding hole and the pressure relief hole, enhancing the far-field sound leakage.

### SUMMARY

An aspect of the present disclosure provides an acoustic output device. The acoustic output device includes a first speaker, a second speaker, a housing, and a support structure. The first speaker includes a first diaphragm configured to generate sound in a first frequency band. The second speaker includes a second diaphragm configured to generate sound in a second frequency band. The second frequency band includes frequencies higher than an upper limit frequency of the first frequency band. The housing is configured to carry the first speaker and the second speaker. The support structure is configured to place the housing near an ear canal without blocking an entrance of the ear canal. At least two sound guiding holes are disposed on the housing. A first sound guiding hole of the at least two sound guiding holes is acoustically coupled to a front side of the first diaphragm and defines a front chamber of the first speaker. A second sound guiding hole of the at least two sound guiding holes is acoustically coupled to a rear side of the first diaphragm and defines a rear chamber of the first speaker. The front chamber has a first resonance frequency. The rear chamber has a second resonance frequency. A higher one of the first resonance frequency and the second resonance frequency is in a range of 3 kHz to 6 kHz

In some embodiments, the higher one of the first resonance frequency and the second resonance frequency is in a range of 4.5 kHz to 5 kHz.

In some embodiments, the second speaker is configured to generate the sound in the second frequency band by performing frequency division processing on a received excitation signal based on a crossover frequency point. A difference between the higher one of the first resonance frequency and the second resonance frequency and the crossover frequency point is in a range of 2 kHz to 3.5 kHz

In some embodiments, the crossover frequency point is in a frequency range of 6 kHz to 9 kHz.

In some embodiments, a volume of the front chamber is in a range of 150 mm³ to 600 mm³.

In some embodiments, an area of the first sound guiding hole is in a range of 10 mm² to 62.5 mm².

In some embodiments, the first sound guiding hole is disposed on an inner side surface of the housing. A ratio of an area of the first sound guiding hole to an area of the inner side surface of the housing is in a range of 0.03 to 0.20. The inner side surface is a side surface of the housing facing an ear in a wearing state.

In some embodiments, the at least two sound guiding holes further include a third sound guiding hole. The second speaker transmits the sound in the second frequency band to outside of the housing through the third sound guiding hole.

In some embodiments, the first sound guiding hole is disposed on an inner side surface of the housing. The third sound guiding hole is disposed on a lower side surface of the housing or on a connecting surface between the inner side surface and the lower side surface. The inner side surface is a side surface of the housing facing an ear in a wearing state. The lower side surface is a side surface of the housing facing away from the top of the head of a user along a short axis direction of the housing in the wearing state.

In some embodiments, the first sound guiding hole and the third sound guiding hole are disposed on an inner side surface of the housing. The inner side surface is a side surface of the housing facing an ear in a wearing state.

In some embodiments, the first sound guiding hole is arranged to at least partially surround the third sound guiding hole.

In some embodiments, the first sound guiding hole is L-shaped. The third sound guiding hole is located on the inner side of the first sound guiding hole.

In some embodiments, a protruding portion is disposed on the inner side surface extending away from the housing along a thickness direction of the housing. At least a portion of the second speaker is disposed within the protruding portion. The third sound guiding hole is disposed on the protruding portion and penetrates through the protruding portion.

In some embodiments, at least a portion of an outer side wall of the protruding portion defines an inner edge of the first sound guiding hole.

In some embodiments, an outer edge of the first sound guiding hole extends to a connecting surface between the inner side surface and at least one of a rear side surface, an upper side surface, and the lower side surface of the housing. An outer side of the first sound guiding hole is a side away from a center of the inner side surface. The rear side surface is a side surface facing a rear of the ear along a long axis direction of the housing in the wearing state. The upper side surface is a side surface close to the top of the head of the user along the short axis direction of the housing in the wearing state. The lower side surface is the side surface facing away from the top of the head of the user along the short axis direction of the housing in the wearing state.

In some embodiments, an outer side of the first sound guiding hole has a barrier wall. The barrier wall increases a dimension of an outer edge wall of the first sound guiding hole along a thickness direction of the housing.

In some embodiments, a distance between an endpoint of a lowermost edge of the first sound guiding hole and the lower side surface of the housing in the short axis direction of the housing is in a range of 1 mm to 9 mm; and/or a distance between an endpoint of an uppermost edge of the first sound guiding hole and an upper side surface of the housing in the short axis direction of the housing is in a range of 1 mm to 9 mm.

In some embodiments, a distance between a rightmost endpoint of the first sound guiding hole and a rear side surface of the housing in a long axis direction of the housing is in a range of 1 mm to 4 mm.

In some embodiments, a vibration direction of the second diaphragm is perpendicular to a plane where an outer opening of the third sound guiding hole is located. A first tilt angle is formed between the plane where the outer opening of the third sound guiding hole is located and the inner side surface of the housing. The first tilt angle is in a range of 3° to 8°.

In some embodiments, a dimension of the first sound guiding hole in a long axis direction of the housing is in a range of 4 mm to 10 mm, and/or a dimension of the first sound guiding hole in a short axis direction of the housing is in a range of 3 mm to 9 mm.

In some embodiments, vibration directions of both the second diaphragm and the first diaphragm are perpendicular to an inner side surface of the housing. A second tilt angle is formed between the inner side surface and an outer side surface of the housing. The second tilt angle is in a range of 3° to 8°. The inner side surface is a side surface of the housing facing an ear in a wearing state.

In some embodiments, vibration directions of both the second diaphragm and the first diaphragm are perpendicular to both an inner side surface and an outer side surface of the housing. The inner side surface is a side surface of the housing facing an ear in a wearing state. The outer side surface is a side surface of the housing facing away from the ear in the wearing state. The support structure includes an ear hook, in a non-wearing state, a first distance between an ear hook plane of the ear hook and a first position is less than a second distance between the ear hook plane and a second position. The first position is a midpoint of an upper edge of the inner side surface. The second position is a midpoint of a lower edge of the inner side surface.

An aspect of the present disclosure provides an acoustic output device. The acoustic output device includes a first speaker, a second speaker, a housing, and a support structure. The first speaker includes a first diaphragm configured to generate sound in a first frequency band. The second speaker includes a second diaphragm configured to generate sound in a second frequency band. The second frequency band includes frequencies higher than an upper limit frequency of the first frequency band. The housing is configured to carry the first speaker and the second speaker. The support structure is configured to place the housing near an ear canal without blocking an entrance of the ear canal. At least two sound guiding holes are disposed on the housing. A first sound guiding hole of the at least two sound guiding holes is acoustically coupled to a front side of the first diaphragm and defines a front chamber of the first speaker. A second sound guiding hole of the at least two sound guiding holes is acoustically coupled to a rear side of the first diaphragm and defines a rear chamber of the first speaker. The front chamber of the first speaker has a first resonance frequency. A volume of the front chamber of the first speaker is configured to perform attenuation on sound output by the first speaker at frequencies higher than the first resonance frequency. The attenuation causes sound in a range of 1.0 kHz to 1.5 kHz higher than the first resonance frequency to be attenuated by not less than 8 dB compared to sound at the first resonance frequency.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary ear according to some embodiments of the present disclosure;

FIG. 2 is a schematic diagram illustrating an exemplary structure of an acoustic output device according to some embodiments of the present disclosure;

FIG. 3 is a schematic diagram illustrating an exemplary wearing state of an acoustic output device according to some embodiments of the present disclosure;

FIG. 4 is a schematic diagram illustrating a structure of an acoustic output device in a non-wearing state according to some embodiments of the present disclosure;

FIG. 5 is a schematic diagram illustrating an exemplary wearing state of an acoustic output device according to some other embodiments of the present disclosure;

FIG. 6 is a schematic diagram illustrating an exemplary internal structure of an acoustic output device according to some embodiments of the present disclosure;

FIG. 7 is a schematic diagram illustrating frequency response curves of a front chamber corresponding to different chamber volumes according to some embodiments of the present disclosure;

FIG. 8 is a schematic diagram illustrating an exemplary inner side surface of a housing according to some embodiments of the present disclosure;

FIG. 9 is a schematic diagram illustrating an exemplary first diaphragm according to some embodiments of the present disclosure;

FIG. 10 is a schematic diagram illustrating another exemplary inner side surface of a first speaker according to some embodiments of the present disclosure;

FIG. 11 is a schematic diagram illustrating another exemplary inner side surface of a first speaker according to some embodiments of the present disclosure;

FIG. 12 is a schematic diagram illustrating yet another exemplary inner side surface of a first speaker according to some embodiments of the present disclosure;

FIG. 13 is a schematic diagram illustrating yet another exemplary inner side surface of a first speaker according to some embodiments of the present disclosure;

FIG. 14 is a schematic diagram illustrating frequency response curves of two acoustic output devices according to some embodiments of the present disclosure;

FIG. 15 is a schematic diagram illustrating frequency response curves of a front chamber before and after a design according to some embodiments of the present disclosure;

FIG. 16 is a schematic diagram illustrating an exemplary structure of an acoustic output device according to some embodiments of the present disclosure;

FIG. 17 is a schematic diagram illustrating another exemplary structure of an acoustic output device according to some embodiments of the present disclosure; and

FIG. 18 is a schematic diagram illustrating yet another exemplary structure of an acoustic output device according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same number in the drawings refers to the same structure or operation.

It will be understood that the terms “system,” “device,” “unit,” and/or “module” used herein are one method to distinguish different components, elements, parts, sections, or assemblies of different levels in ascending order. However, the terms may be displaced by other expressions if they may achieve the same purpose.

As used herein, the singular forms “a,” “an,” and “the” may be intended to include the plural forms as well, unless the context clearly indicates otherwise. It will be further understood that the terms “include” and/or “comprise,” when used in the present disclosure, only indicate the inclusion of explicitly identified operations and elements, which do not form an exhaustive list. Methods or devices may also contain other steps or elements.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

FIG. 1 is a schematic diagram illustrating an exemplary ear according to some embodiments of the present disclosure. Referring to FIG. 1, an ear 100 (which may also be referred to as an auricle) may include an ear canal 101, a concha cavity 102, a concha cymba 103, a triangular fossa 104, an antihelix 105, a scaphoid fossa 106, a helix 107, an earlobe 108, a tragus 109, and a crus of helix 1071. In some embodiments, the stability of wearing the acoustic output device may be achieved by supporting the acoustic output device with one or more portions of the ear 100. In some embodiments, portions such as the ear canal 101, the concha cavity 102, the concha cymba 103, and the triangular fossa 104 have a certain depth and volume in three-dimensional space, which may be used to meet wearing requirements of the acoustic output device. For example, the acoustic output device (e.g., an in-ear headphone) may be worn in the ear canal 101. In some embodiments, the acoustic output device may be worn using other portions of the ear 100 besides the ear canal 101. For example, the acoustic output device may be worn using a portion such as the concha cymba 103, the triangular fossa 104, the antihelix 105, the scaphoid fossa 106, the helix 107, or a combination thereof. In some embodiments, the earlobe 108 or other portions of the user may be utilized to improve the comfort and reliability of wearing the acoustic output device. By utilizing other portions of the ear 100 besides the ear canal 101 to achieve wearing of the acoustic output device and sound propagation, the ear canal 101 of the user may be “liberated”. When the user wears the acoustic output device, the acoustic output device does not block the ear canal 101 (or an entrance of the ear canal) of the user. The user may receive sound from the acoustic output device and sound from the environment (e.g., horn sound, bicycle bell sound, surrounding human voices, traffic command sound, etc.), thereby reducing the probability of traffic accidents. In the present disclosure, when worn by the user, the acoustic output device that does not block the ear canal 101 (or the entrance of the ear canal) of the user may be referred to as an open earphone. In some embodiments, the acoustic output device may be designed to have a structure adapted to the ear 100 based on the structure of the ear 100, to achieve the wearing of a housing of the acoustic output device at various different positions on the ear. For example, when the acoustic output device is an earphone, the earphone may include a suspension structure (e.g., an ear hook) and a housing. The housing is physically connected to the suspension structure. The suspension structure may be adapted to a shape of the auricle to place an entirety or a portion of the housing on a front side of the tragus 109 (e.g., a region M₃ enclosed by a dashed line in FIG. 1). As another example, when the user wears the earphone, an entirety or a portion of the housing may contact an upper portion of the ear canal 101 (e.g., a position where one or more portions such as the concha cymba 103, the triangular fossa 104, the antihelix 105, the scaphoid fossa 106, the helix 107, and the crus of helix 1071 are located). As yet another example, when the user wears the earphone, an entirety or a portion of the housing may be located in a chamber (e.g., a region M₁ including at least the concha cymba 103 and the triangular fossa 104 and a region M₂ including at least the concha cavity 102, the region M₁ and the region M₂ are enclosed by dashed lines in FIG. 1) formed by one or more portions (e.g., the concha cavity 102, the concha cymba 103, the triangular fossa 104, etc.) of the ear 100.

Different users may have individual differences, resulting in differences in the ear such as shapes and dimensions. For ease of description and understanding, unless otherwise specified, the present disclosure will mainly use an ear model with a “standard” shape and dimension as a reference to further describe the wearing manner of the acoustic output device in different embodiments on the ear model. For example, a simulator including a head and (left and right) ears of the head manufactured based on ANSI: S3.36, S3.25, and IEC: 60318-7 standards, such as GRAS 45BC KEMAR, may be used as a reference for wearing the acoustic output device, thereby presenting a scenario where most users normally wear the acoustic output device. Merely by way of example, the reference ear may have the following relevant features: a dimension of a projection of the auricle on a sagittal plane in a direction of a vertical axis may be in a range of 49.5 mm to 74.3 mm, and a dimension of the projection of the auricle on the sagittal plane in a direction of a sagittal axis may be in a range of 36.6 mm to 55 mm. Therefore, in the present disclosure, descriptions such as “user wearing”, “user wears”, and “in a wearing state” may refer to the acoustic output device described in the present disclosure being worn on the ear of the aforementioned simulator. Certainly, considering individual differences among different users, structures, shapes, sizes, thicknesses, etc., of one or more portions of the ear 100 may have certain differences. To meet requirements of different users, the acoustic output device may be differentially designed. These differential designs may be reflected in that feature parameters of one or more portions of the acoustic output device (e.g., the housing, the ear hook, etc., described below) may have values in different ranges to adapt to different ears.

It should be noted that in fields such as medicine and anatomy, three basic planes of the human body, namely a sagittal plane, a coronal plane, and a horizontal plane, and three basic axes, namely a sagittal axis, a coronal axis, and a vertical axis, may be defined. The sagittal plane refers to a plane perpendicular to the ground along an anterior-posterior direction of the body, which divides the body into left and right portions. The coronal plane refers to a plane perpendicular to the ground along a left-right direction of the body, which divides the body into anterior and posterior portions. The horizontal plane refers to a plane parallel to the ground along a direction perpendicular to the superior-inferior direction of the body, which divides the body into superior and inferior portions. Correspondingly, the sagittal axis refers to an axis along the anterior-posterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. The “front side of the ear” described in the present disclosure is a concept relative to a “rear side of the ear”. The former refers to a side of the ear facing away from the head, and the latter refers to a side of the ear facing towards the head. A schematic diagram of a front side contour of the ear as shown in FIG. 1 may be obtained by observing the ear of the simulator along a direction of the coronal axis of the human body.

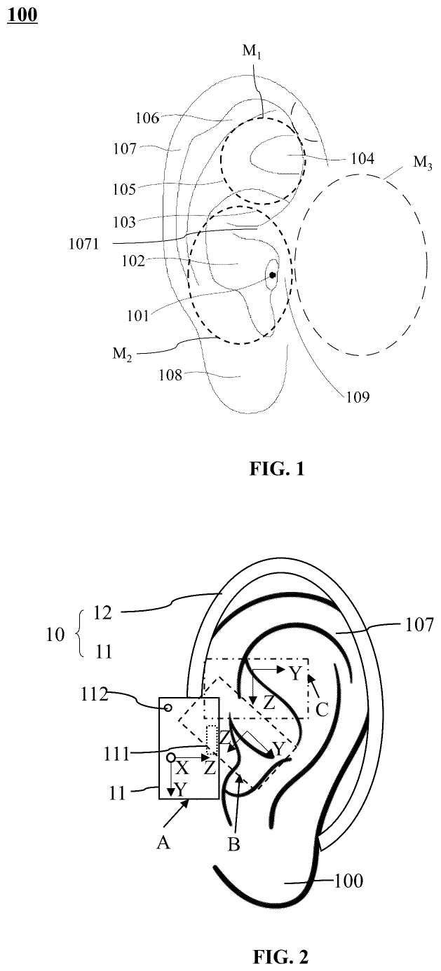

FIG. 2 is a schematic diagram illustrating an exemplary structure of an acoustic output device according to some embodiments of the present disclosure.

In some embodiments, the acoustic output device 10 may include, but is not limited to, an air conduction earphone, a bone conduction earphone, etc. In some embodiments, the acoustic output device 10 may be combined with products such as glasses, a head-mounted earphone, a head-mounted display device, or an AR/VR helmet. In some embodiments, the acoustic output device 10 may include a low-frequency (e.g., 30˜150 Hz) speaker, a mid-low-frequency (e.g., 150˜500 Hz) speaker, a mid-high-frequency (e.g., 500˜6 kHz) speaker, a high-frequency (e.g., 6 k˜16 kHz) speaker, or a full-frequency (e.g., 30˜16 kHz) speaker, or any combination thereof. The low frequency, high frequency, etc., mentioned here only represent approximate ranges of frequencies. In different application scenarios, the division of frequencies may be different. For example, a crossover frequency point may be determined. “Low frequency” represents a range of frequencies below the crossover frequency point, and “high frequency” represents a range of frequencies above the crossover frequency point.

As shown in FIG. 2, the acoustic output device 10 may include a housing 11 and a support structure 12.

In some embodiments, the acoustic output device 10 may wear the housing 11 on a body (e.g., the human head, the neck, or upper torso) of the user via the support structure 12. In some embodiments, the acoustic output device 10 may secure the housing 11 near an ear canal without blocking the entrance of the ear canal via the support structure 12, allowing the user to receive sound played by the earphone and clearly perceive ambient sound.

In some embodiments, one end of the support structure 12 may be connected to the housing 11, and another end of the support structure 12 may extend along a junction between the ear 100 and the head of the user. In some embodiments, the support structure 12 may be an arc-shaped structure adapted to the ear 100 of the user, so that the support structure 12 may be suspended on the ear 100 of the user. For example, the support structure 12 may have an arc-shaped structure adapted to the junction between the ear 100 and head of the user, so that the support structure 12 may be hooked between the ear 100 and the head of the user. In some embodiments, the support structure 12 may also be a clamping structure adapted to the ear 100 of the user, so that the support structure 12 may be clamped to the ear 100 of the user. In some embodiments, the support structure 12 may include, but is not limited to, a suspension structure, an elastic band, etc., so that the acoustic output device 10 may be better fixed on the body of the user to prevent falling during use. In some embodiments, the acoustic output device 10 may not include the support structure 12. The housing 11 may be fixed near the ear 100 of the user by suspension or clamping.

Merely by way of example, when the acoustic output device 10 is in a wearing state, the support structure 12 may be hooked between a rear side of the ear 100 and the head of the user. The housing 11 may contact a front side of the ear 100 (e.g., the region M₃ in FIG. 1) of the user or directly contact the ear 100 (e.g., the regions M₁ and M₂ in FIG. 1). The support structure 12 or the support structure 12 in cooperation with the housing 11 may provide a pressing force for the housing 11 against the front side of the ear 100 or against the ear 100. The housing 11 may press against the front side of the ear 100 or a region where the concha cavity 102, the concha cymba 103, the triangular fossa 104, the antihelix 105, etc., are located under the pressing force, so that the acoustic output device 10 does not block the ear canal 101 of the ear 100 in the wearing state.

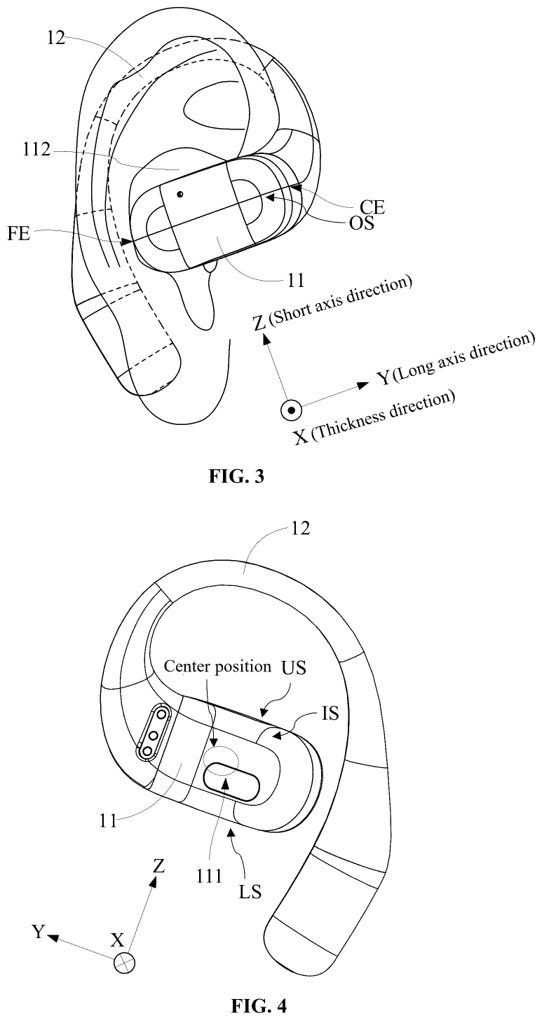

In some embodiments, the housing 11 may have a regular shape (e.g., circular, elliptical, racetrack-shaped, polygonal, U-shaped, V-shaped, semicircular, etc.) or an irregular shape, so that the housing 11 may be hooked on the ear 100 of the user. In some embodiments, as shown in FIG. 3, the housing 11 may have a long axis direction Y, a short axis direction Z, and a thickness direction X that are orthogonal to each other. The long axis direction Y may be defined as a direction corresponding to a larger extension dimension in shapes of two-dimensional projections (e.g., a projection of the housing 11 on a plane where an inner side surface is located, or a projection on the sagittal plane) of the housing 11. For example, when the shape of the projection of the housing is rectangular or approximately rectangular, the long axis direction Y may also be referred to as a length direction of the housing. For ease of description, the present disclosure will use the projection of the housing 11 on the sagittal plane for explanation. The short axis direction Z may be defined as a direction perpendicular to the long axis direction Y in the projection of the housing 11 on the sagittal plane. For example, when the shape of the projection of the housing is rectangular or approximately rectangular, the short axis direction Z may also be referred to as a height direction of the housing. The thickness direction X may be defined as a direction perpendicular to the sagittal plane, e.g., consistent with a direction of a coronal axis, both pointing to left and right sides of the body.

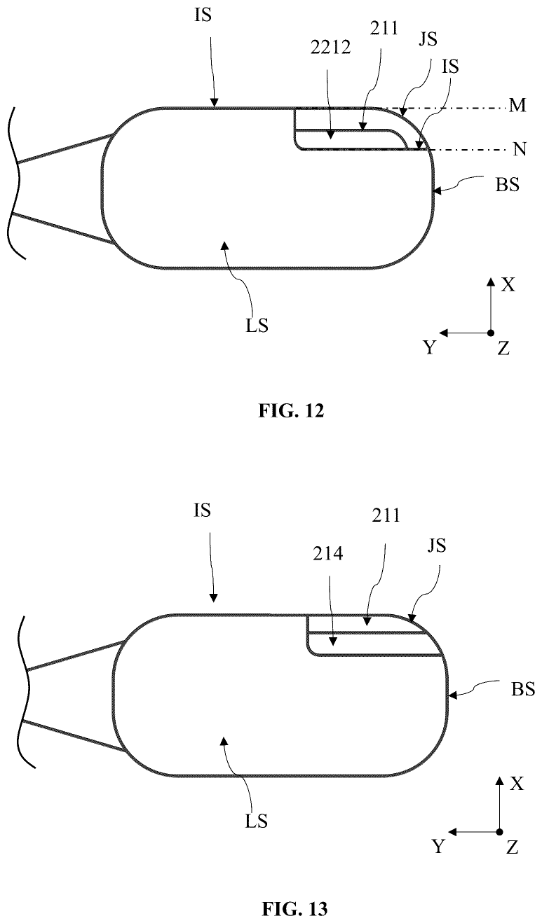

For ease of description, the present disclosure defines different side surfaces for the housing, including an inner side surface, an outer side surface, an upper side surface, a lower side surface, and a rear side surface. The inner side surface (e.g., an inner side surface IS shown in FIG. 4) is a side surface of the housing facing the ear when the acoustic output device is in the wearing state. The outer side surface (e.g., an outer side surface OS shown in FIG. 3) is a side surface of the housing facing away from the ear when the acoustic output device is in the wearing state. The upper side surface (e.g., an upper side surface US shown in FIG. 4) is a side surface of the housing close to the top of the head of the user along the short axis direction Z when the acoustic output device is in the wearing state. The lower side surface (e.g., a lower side surface LS shown in FIG. 4) is a side surface of the housing facing away from the top of the head of the user along the short axis direction Z when the acoustic output device is in the wearing state. The rear side surface (e.g., a rear side surface BS shown in FIG. 12) is a side surface facing the rear of the ear along the long axis direction Y in the wearing state, i.e., a side surface where a distal end FE of the housing is located. The following descriptions in the present disclosure are based on this housing structure.

In some embodiments, the housing 11 may include at least one chamber. The at least one chamber may carry at least two speakers. For example, the housing 11 may include two chambers. A first speaker may be disposed in one chamber. The first speaker includes a first diaphragm configured to generate sound in a first frequency band. A second speaker may be disposed in the other chamber. The second speaker includes a second diaphragm configured to generate sound in a second frequency band. The first diaphragm and the second diaphragm may receive corresponding excitation signals and convert the excitation signals into sound wave output. The first diaphragm and the second diaphragm generate corresponding mechanical vibrations in response to the received excitation signals (e.g., electrical signals) to produce sound. In some embodiments, the housing 11 may also carry a voice coil and a magnetic circuit assembly. One end of the voice coil is fixedly connected to the diaphragm (e.g., the first and second diaphragms), and another end extends into a magnetic gap formed by the magnetic circuit assembly. By providing current to the voice coil, the voice coil may vibrate in the magnetic gap, thereby driving the diaphragm (e.g., the first and second diaphragms) to vibrate to generate sound waves. More content regarding the first speaker and the second speaker may be found in related descriptions elsewhere in the present disclosure. As another example, the housing 11 may also include one chamber. The chamber may simultaneously carry the first speaker and the second speaker.

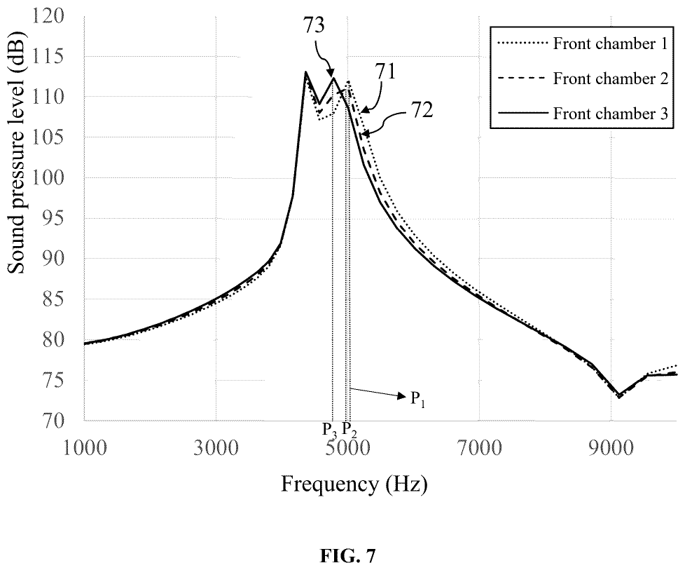

In some embodiments, a front side and a rear side of the first diaphragm may partition a corresponding chamber in the housing 11 to form a front chamber and a rear chamber of the acoustic output device. A first sound guiding hole 111 is disposed on the housing 11 and acoustically coupled to the front chamber, and guides sound generated in the front chamber out of the housing 11. A second sound guiding hole 112 is disposed on the housing 11 and acoustically coupled to the rear chamber, and guides sound generated in the rear chamber out of the housing 11. In some embodiments, the first sound guiding hole 111 may be disposed on the inner side surface IS of the housing 11 close to or facing the ear 100, so that the first sound guiding hole faces or is close to the entrance of the ear canal, thereby allowing the first sound guiding hole 111 to guide sound generated by the diaphragm out of the housing 11 and toward the ear canal for the user to hear. The front chamber has a first resonance frequency. The rear chamber has a second resonance frequency. A higher one of the first resonance frequency and the second resonance frequency is in a range of 3 k to 6 kHz. This allows attenuation of sound in a higher frequency band prone to sound leakage by adjusting the first resonance frequency or the second resonance frequency, which is beneficial for reducing sound leakage of the acoustic output device 10. More content regarding the housing 11, the first sound guiding hole 111, and the second sound guiding hole 112 may be found elsewhere in the present disclosure, e.g., FIG. 6 and related descriptions thereof.

The description of the acoustic output device 10 above is for illustrative purposes only and is not intended to limit the scope of the present disclosure. Various changes and modifications can be made by those of ordinary skill in the art based on the description of the present disclosure. For example, the acoustic output device 10 may further include a battery assembly, a Bluetooth assembly, or a combination thereof. The battery assembly may be configured to power the acoustic output device 10. The Bluetooth assembly may be configured to wirelessly connect the acoustic output device 10 to other devices (e.g., a mobile phone, a computer, etc.). These changes and modifications still fall within the protection scope of the present disclosure.

In some embodiments, when the user wears the acoustic output device 10, the housing 11 may be worn near the ear canal of the user without blocking the ear canal 101. In some embodiments, in the wearing state, a projection of the acoustic output device 10 on the sagittal plane may not cover the ear canal 101 of the user. For example, a projection of the housing 11 on the sagittal plane may fall on left and right sides of the head and at a position on a front side of the tragus on a sagittal axis of the human body (e.g., a position shown by a solid-line box A in FIG. 2). At this time, the housing 11 is located on the front side of the tragus. A long axis of the housing 11 may be in a vertical or approximately vertical state. A projection of the short axis direction Z on the sagittal plane is consistent with the direction of the sagittal axis. A projection of the long axis direction Y on the sagittal plane is consistent with the direction of the vertical axis. The thickness direction X is perpendicular to the sagittal plane. As another example, the projection of the housing 11 on the sagittal plane may fall on the antihelix 105 (e.g., a position shown by a dashed-line box C in FIG. 2). At this time, at least a portion of the housing 11 is located at the antihelix 105. The long axis of the housing 11 is in a horizontal or approximately horizontal state. The projection of the long axis direction Y of the housing 11 on the sagittal plane is consistent with the direction of the sagittal axis. The projection of the short axis direction Z on the sagittal plane is consistent with the direction of the vertical axis. The thickness direction X is perpendicular to the sagittal plane. Such an arrangement can avoid blocking the ear canal by the housing 11, thereby freeing the ears of user. It can also increase a contact area between the housing 11 and the ear 100, thereby improving the wearing comfort of the acoustic output device 10. In some embodiments, in the wearing state, the projection of the acoustic output device 10 on the sagittal plane may also cover or at least partially cover the ear canal 101 of the user. For example, the projection of the housing 11 on the sagittal plane may fall within the concha cavity 102 (e.g., a position shown by a dashed-line box B in FIG. 2) and contact the crus of helix 1071 and/or the helix 107. At this time, at least a portion of the housing 11 is located in the concha cavity 102. The housing 11 is in an inclined state. The projection of the short axis direction Z of the housing 11 on the sagittal plane may form an angle with the direction of the sagittal axis, i.e., the short axis direction Z is also inclined accordingly. The projection of the long axis direction Y on the sagittal plane may form an angle with the direction of the sagittal axis, i.e., the long axis direction Y is also inclined. The thickness direction X is perpendicular to the sagittal plane.

It should be understood that sound guided out via the first sound guiding hole 111 may be propagated to the exterior of the acoustic output device 10 and the ear 100, thereby forming first sound leakage in a far field. The second sound guiding hole 112 is farther from the entrance of the ear canal than the first sound guiding hole 111. Sound propagated from the second sound guiding hole 112 forms second sound leakage in the far field. The first sound leakage and the second sound leakage may cancel each other out in the far field, reducing the sound leakage of the acoustic output device 10 in the far field.

Merely by way of example, referring to FIG. 3, in the wearing state, the distal end FE of the housing 11 may extend into a concha cavity. In some embodiments, the housing 11 and the support structure 12 may be configured to clamp the ear 100 from front and rear sides corresponding to a region of the ear 100 associated with the concha cavity 102, thereby increasing the resistance of the acoustic output device 10 to detach from the ear 100 and improving the stability of the acoustic output device 10 in the wearing state. For example, the distal end FE of the housing presses against the concha cavity in the thickness direction X. As another example, the distal end FE abuts against the concha cavity in the long axis direction Y and/or a short axis direction Z (e.g., abuts against an inner wall of the concha cavity opposite the distal end FE). It should be noted that the distal end FE of the housing 11 refers to an end of the housing 11 disposed opposite to a connection end CE connected to the support structure 12, and is also referred to as a free end. The housing 11 may be a regular or irregular structure. To further illustrate the distal end FE of the housing 11, an exemplary description of the distal end FE is provided. For example, when the housing 11 has a cuboid structure, an end wall of the housing 11 is planar. In this case, the distal end FE of the housing 11 is a side wall of the end of the housing 11 disposed opposite to the connection end CE connected to the support structure 12. As another example, when the housing 11 is a sphere, an ellipsoid, or an irregular structure, the distal end FE of the housing 11 may refer to a specific region obtained by cutting the housing 11 along an X˜Z plane (a plane formed by the short axis direction Z and the thickness direction X) that is away from the connection end CE. A ratio of a dimension of the specific region along the long axis direction Y to a dimension of the housing along the long axis direction Y may be in a range of 0.05 to 0.2.

In some embodiments, referring to FIG. 3 and FIG. 4, the first sound guiding hole 111 may be disposed on the side wall (e.g., the inner side surface IS) of the housing 11 facing the ear 100 to guide sound generated by the front chamber of the first speaker out of the housing 11 and toward the ear canal 101, enabling the user to hear the sound. In some embodiments, one or more second sound guiding holes 112 acoustically coupled to the rear chamber may be disposed on other side surfaces of the housing 11 besides the inner side surface IS (e.g., the upper side surface US, the lower side surface LS, or the outer side surface OS) to guide sound generated in the rear chamber of the first speaker out of the housing 11 for interference cancellation with the sound guided out from the first sound guiding hole 111 in the far field. In some embodiments, the one or more second sound guiding holes 112 are farther from the ear canal than the first sound guiding hole 111 to achieve the out-of-phase cancellation between the sound output via the one or more second sound guiding holes 112 and the sound output via the first sound guiding hole 111 at a listening position. By extending at least a portion of the housing 11 into the concha cavity 102, a listening volume at the listening position (e.g., at the entrance of the ear canal) can be increased while maintaining a good sound leakage cancellation effect in the far field.

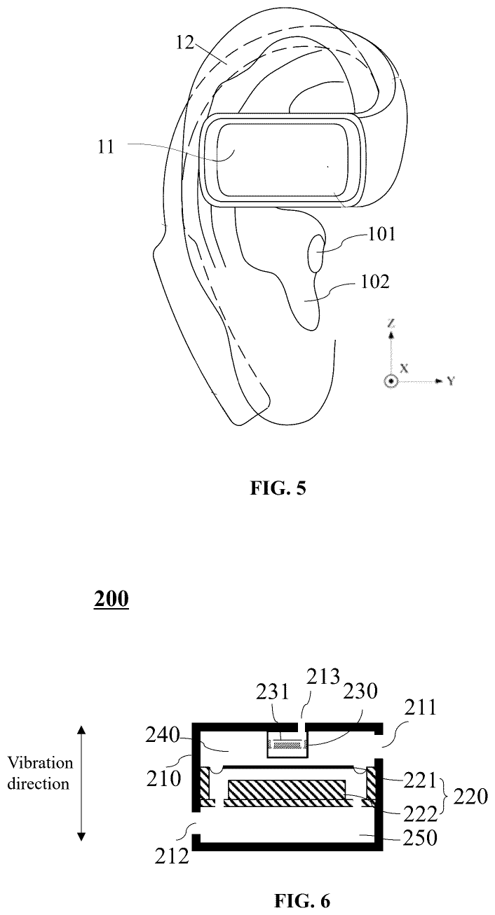

In some embodiments, the acoustic output device may have other wearing manners different from extending into the concha cavity as shown in FIG. 3. As shown in FIG. 5, in the wearing state of the acoustic output device 10, at least a portion of the housing 11 may cover an antihelix region of the user. In this case, the first sound guiding hole is located on a side wall of the housing 11 facing or near the ear canal 101 of the user. The second sound guiding hole is located on a side wall of the housing 11 away from or facing away from the ear canal 101 of the user. The housing 11 and the ear 100 of the user may be regarded as a baffle structure. The first sound leakage and the second sound leakage may interfere and cancel each other over a large spatial range without needing to bypass the baffle (similar to a no-baffle scenario). Sound leakage in the far field does not increase significantly. Therefore, with this configuration, the volume at a listening position in the near field can also be significantly improved without a significant increase in the sound leakage volume in the far field.

If the first sound leakage and the second sound leakage include sound in a higher frequency band (e.g., sound with a frequency above 6 kHz) and sound in a lower frequency band (e.g., sound with a frequency less than 3 kHz), the phase of the sound in the lower frequency band of the first sound leakage and the second sound leakage is substantially unaffected by a chamber structure of the acoustic output device (the front chamber structure and/or the rear chamber structure). The first sound leakage and the second sound leakage may cancel each other out in the far field, reducing the far-field sound leakage. Sound in the higher frequency band has a shorter wavelength. Under the far-field condition, a distance between two sound sources (i.e., a sound source corresponding to the first sound guiding hole 111 and a sound source corresponding to the second sound guiding hole 112) is not negligible relative to the wavelength, causing sound signals emitted by the two sound sources to fail to cancel out. Additionally, when an acoustic transmission structure of the acoustic output device resonates, an actual phase of sound signals radiated from the first sound guiding hole 111 and the second sound guiding hole 112 has a certain phase difference from an original phase at a sound generation position. An additional resonance peak is added to the transmitted sound wave, causing a chaotic sound field distribution and making it difficult to ensure reduction effect of the far-field sound leakage at high frequencies, which may even increase sound leakage. Therefore, it is necessary to process sound in the higher frequency band output from the first sound guiding hole and the second sound guiding hole to avoid significant far-field sound leakage in the higher frequency band.

In some embodiments of the present disclosure, to solve the sound leakage problem of the acoustic output device in the higher frequency band, the acoustic output device may be configured to output sound in the lower frequency band through the first speaker and output sound in the higher frequency band through the second speaker. In some embodiments, the first speaker is similar to related structures of the aforementioned acoustic output device. The first speaker includes the first diaphragm. A front side and a rear side of the first diaphragm partition a corresponding chamber in the housing to form a front chamber and a rear chamber. A first sound guiding hole is disposed on the housing and acoustically coupled to the front chamber and guides sound generated in the front chamber out of the housing. A second sound guiding hole is disposed on the housing and acoustically coupled to the rear chamber and guides sound generated in the rear chamber out of the housing. In some embodiments, the first speaker may output only sound in the lower frequency band. In the lower frequency band, the phases of the first sound leakage and the second sound leakage generated by the first speaker are substantially unaffected by the chamber structure of the acoustic output device (the front chamber structure and/or the rear chamber structure). The first sound leakage and the second sound leakage can cancel each other out in the far field, reducing far-field sound leakage. The second speaker may output only sound in the higher frequency band. Utilizing the strong directivity exhibited by the sound in the higher frequency band, the sound in the higher frequency band can be primarily radiated toward a direction of the human ear canal, thereby reducing sound leakage. The lower frequency band refers to a lower frequency portion of an audio frequency spectrum (e.g., a portion with a frequency less than 5 kHz). The higher frequency band refers to a higher frequency portion of the audio frequency spectrum (e.g., a portion with a frequency above 6 kHz).

In some embodiments, to enable the first speaker to output only sound in the lower frequency band, output of sound in the higher frequency band by the first speaker may be suppressed by adjusting a chamber resonance frequency of the first speaker (e.g., a resonance frequency of the front chamber and/or the rear chamber), thereby weakening far-field sound leakage of the first speaker in the higher frequency band. Specifically, due to resonance of the front chamber and/or the rear chamber of the first speaker, in a frequency band lower than or near a resonance frequency of the chamber structure (a resonance frequency of the front chamber or the rear chamber), the sound output from the first sound guiding hole or the second sound guiding hole has less attenuation and a higher sound pressure level. In a frequency band higher than and far from the resonance frequency, the sound output from the first sound guiding hole or the second sound guiding hole attenuates quickly, and the sound pressure level decreases rapidly. Therefore, the resonance frequency of the front chamber and/or the rear chamber may be adjusted toward the lower frequency band. In this case, sound in the higher frequency band above the resonance frequency can attenuate rapidly, and the sound pressure level decreases, achieving a “low-pass filtering” effect, thereby reducing the output of the first speaker in the higher frequency band and the resulting sound leakage. Compared to using hardware to perform low-pass filtering on an electrical signal input to the first speaker, the manner of attenuating sound waves using the chamber structure has significant advantages. For example, if a low-order low-pass filter (e.g., a first-order low-pass filter) is used, its limited roll-off rate provides insufficient attenuation of the higher-frequency components in the electrical signal. As a result, the first speaker may still output a significant amount of high-frequency sound. If a high-order low-pass filter is used, more electronic components are required, which not only introduces additional resistance that reduces the sensitivity of the first speaker but also increases the cost of the acoustic output device. Therefore, utilizing a property that sound waves from the first speaker with frequencies greater than the chamber resonance frequency are rapidly attenuated, and through a reasonable design of the chamber of the first speaker, the chamber resonance frequency is shifted to a lower range, and sound waves in the higher frequency band are greatly attenuated, thereby achieving an ideal reduction effect of the sound leakage for the sound output device across the full frequency band.

The first speaker and the second speaker included in the acoustic output device and related structures will be further described below with reference to FIG. 6 to FIG. 18.

FIG. 6 is a schematic diagram illustrating an exemplary internal structure of an acoustic output device according to some embodiments of the present disclosure.

As shown in FIG. 6, an acoustic output device 200 may include a housing 210, a first speaker 220, and a second speaker 230. The acoustic output device 200 may further include a support structure (e.g., the support structure 12, not shown in figures).

The housing 210 is configured to carry the first speaker 220 and the second speaker 230. In some embodiments, the housing 210 forms an accommodation chamber for accommodating other components of the acoustic output device 200 (including the first speaker 220 and the second speaker 230). The housing 210 provides protection for components accommodated in the accommodation chamber.

The support structure may be configured to support the acoustic output device 200. When the acoustic output device 200 is in the wearing state, the support structure is located on the ear and supports the housing 210. The support structure may position the housing 210 near the ear canal without blocking the entrance of the ear canal. For more description regarding the support structure, refer to related descriptions regarding the support structure 12 in FIG. 2 of the present disclosure.

The first speaker 220 is configured to generate sound in a first frequency band. The first speaker 220 may convert an electrical signal (e.g., an audio signal) into a sound signal and output the sound signal. In some embodiments, the first speaker 220 includes a first diaphragm 221. The first diaphragm 221 is accommodated in the accommodation chamber formed by the housing 210. The first diaphragm 221 partitions the accommodation chamber into a front chamber 240 and a rear chamber 250. The first diaphragm 221 has a front side and a rear side. The front side of the first diaphragm 221 and the accommodation chamber form the front chamber 240. The rear side of the first diaphragm 221 and the accommodation chamber form the rear chamber 250.

In some embodiments, the first speaker 220 further includes a first magnet 222. The first diaphragm 221 and the first magnet 222 are spaced apart along a vibration direction (referring to FIG. 6) of the first diaphragm 221. The vibration direction of the first diaphragm 221 is perpendicular to an extension direction of the first diaphragm 221. In some embodiments, the first magnet 222 is located in the rear chamber 250. That is, the first magnet 222 is disposed close to the rear side of the first diaphragm 221. The first magnet 222 is configured to generate a magnetic field. When a coil connected to the first diaphragm 221 is energized, the coil moves in the magnetic field generated by the first magnet 222, thereby driving the first diaphragm 221 to vibrate. At this time, the front side and the rear side of the first diaphragm 221 may serve as a sound wave generation structure, respectively, to produce a set of sound (or sound waves) with equal amplitude and (approximately) opposite phases. Sound generated by the front side of the first diaphragm 221 radiates outward through the front chamber 240. Sound generated by the rear side of the first diaphragm 221 radiates outward through the rear chamber 250.

In some embodiments, a first sound guiding hole 211 and a second sound guiding hole 212 are disposed on the housing 210. The front chamber 240 may be acoustically coupled to the first sound guiding hole 211. The rear chamber 250 may be acoustically coupled to the second sound guiding hole 212. The set of sound with equal amplitude and opposite phases generated by the first diaphragm 221 may radiate outward through the first sound guiding hole 211 and the second sound guiding hole 212, respectively. In the present disclosure, a sound guiding hole (e.g., the first sound guiding hole 211, the second sound guiding hole 212, or a third sound guiding hole 213 described later) refers to a hole structure with a certain depth that penetrates the housing 210. The sound guiding hole has an outer opening located on an outer side of the housing 210 and an inner opening located on an inner side of the housing 210. It is worth noting that, in the present disclosure, when describing relevant features (e.g., an area, a dimension, etc.) of the sound guiding hole, unless otherwise specified, it refers to the relevant features of the outer opening of the sound guiding hole. For example, the area of the first sound guiding hole 211 involved in the present disclosure specifically refers to the area of the outer opening of the first sound guiding hole 211.

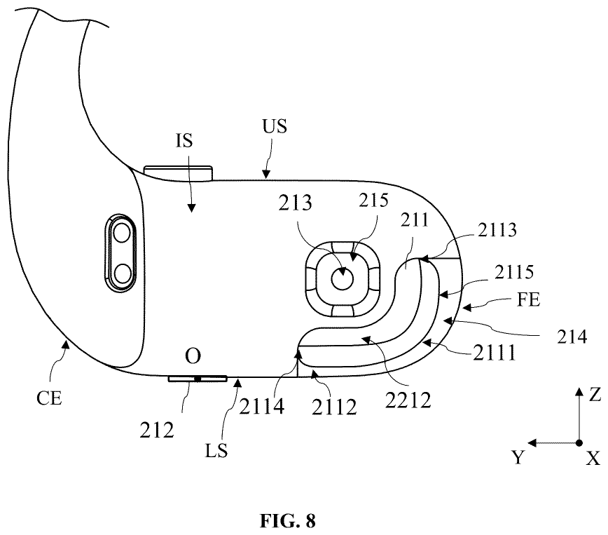

When the user wears the acoustic output device 200, the acoustic output device 200 may be located near the ear canal of the user. The first sound guiding hole 211 may face the entrance of the ear canal of the user. The second sound guiding hole 212 may be farther from the entrance of the ear canal than the first sound guiding hole 211. A distance between the first sound guiding hole 211 and the entrance of the ear canal may be less than a distance between the second sound guiding hole 212 and the entrance of the ear canal. In some embodiments, the first sound guiding hole 211 may be disposed on a side surface of the housing 210 that is close to or faces the ear canal of the user (e.g., the inner side surface IS). The second sound guiding hole 212 may be disposed on another side surface of the housing 210 that is away from the ear canal of the user (e.g., the upper side surface US, the lower side surface LS, or the outer side surface OS). For example, the first sound guiding hole 211 is disposed on the inner side surface IS of the housing 210 facing the ear canal of the user. The second sound guiding hole 212 is disposed on the outer side surface OS of the housing 210 away from the ear canal of the user. For a description of the positions of the first sound guiding hole 211 and the second sound guiding hole 212, refer to related content in FIG. 3 and FIG. 4 of the present disclosure. For further description of the first sound guiding hole 211 and the second sound guiding hole 212, refer to related content in FIG. 8 of the present disclosure.

The second speaker 230 is configured to generate sound in a second frequency band. In some embodiments, the second speaker 230 is accommodated in the accommodation chamber formed by the housing 210. The second speaker 230 may convert an electrical signal (e.g., an audio signal) into a sound signal and output the sound signal. In some embodiments, the structure of the second speaker 230 is substantially the same as the structure of the first speaker 220. Specifically, the second speaker 230 includes a second diaphragm 231. Similar to the first diaphragm 221, the second diaphragm 231 has a front side and a rear side. When the second diaphragm 231 vibrates, the front side and the rear side of the second diaphragm 231 generate sound, respectively. The second speaker 230 further includes a second magnet. The second magnet and the second diaphragm 231 are spaced apart along a vibration direction of the second diaphragm 231. In some embodiments, the second magnet is disposed close to the rear side of the second diaphragm 231. In some embodiments, the structure of the second speaker 230 is substantially the same as the structure of the first speaker 220, but differs in the dimension design of various components (e.g., the magnet and the diaphragm). For more content regarding the structure of the second speaker 230, reference may be made to the related description of the first speaker 220.

In some embodiments, the third sound guiding hole 213 is disposed on the housing 210. The third sound guiding hole 213 is acoustically coupled to the front side of the second diaphragm 231 and defines the front chamber of the second speaker 230. Sound generated at the front side of the second diaphragm 231 may radiate outward through the third sound guiding hole 213.

When the user wears the acoustic output device 200, the acoustic output device 200 may be located near the ear canal of the user. The third sound guiding hole 213 may face the entrance of the ear canal of the user. In some embodiments, the third sound guiding hole 213 and the first sound guiding hole 211 may both be disposed on the inner side surface IS of the housing 210 close to the ear canal of the user. In some embodiments, the third sound guiding hole 213 may be non-coplanar with the first sound guiding hole 211. For example, the first sound guiding hole 211 is disposed on the inner side surface IS of the housing 210 close to the ear canal of the user. The third sound guiding hole 213 is disposed on another side surface of the housing 210 close to the ear canal of the user. As another example, the third sound guiding hole 213 may also be disposed on the lower side surface LS of the housing 210 or on a connecting surface (e.g., a junction surface JS shown in FIG. 12) between the lower side surface LS and the inner side surface IS. In this case, the second sound guiding hole 212 may be disposed on the outer side surface OS of the housing 210 away from the ear canal of the user to avoid sound wave interference between the first sound guiding hole 211 and the third sound guiding hole 213 at the near field. In some embodiments, the first sound guiding hole 211 and the third sound guiding hole 213 may be the same sound guiding hole, or may be two separately disposed sound guiding holes which are not communicated with each other.

Referring to FIG. 6, in some embodiments, the second speaker 230 may be located in the front chamber of the first speaker 220. In this case, the second speaker 230 may be fixed to the inner side wall of the housing 210 via a support structure (not shown in the figure). The front chamber of the second speaker 230 is not in communication with the chamber of the first speaker 220. In some embodiments, the vibration direction of the first speaker 220 is parallel or substantially parallel to the vibration direction of the second speaker 230. In other embodiments, the arrangement of the second speaker 230 and the first speaker 220 is not limited to the manner shown in FIG. 6. For example, the second speaker 230 may be disposed independently of the first speaker 220. As another example, the vibration direction of the second speaker 230 may be arranged at a certain angle to the vibration direction of the first speaker 220.

In some embodiments, the first frequency band and the second frequency band may have an overlapping portion, or may be completely different. In some embodiments, the second frequency band includes frequencies higher than an upper limit frequency of the first frequency band. In this case, the first speaker 220 may serve as a low-frequency speaker or a mid-low-frequency speaker. The sound output by the first speaker 220 is low-frequency sound or mid-low-frequency sound. The second speaker 230 serves as a high-frequency speaker or a mid-high-frequency speaker. The sound output by the second speaker 230 is high-frequency sound or mid-high-frequency sound. It should be noted that the low frequency and high frequency mentioned here only represent approximate ranges of frequencies. In different application scenarios, the division of frequencies may be different. In some embodiments, the second frequency band may be determined by a crossover frequency point. The second frequency band is a frequency range above the crossover frequency point. For example, if the crossover frequency point is 6 kHz, correspondingly, the second frequency band may be 6 k˜30 kHz. The crossover frequency point may be any value within an audible range of the human, e.g., 500 Hz, 1 kHz, 5 kHz, 6 kHz, 7 kHz, 8 kHz, 9 kHz, etc. In some embodiments, the first frequency band may also be determined by the crossover frequency point. The first frequency band may be a frequency range below the crossover frequency point. For example, if the crossover frequency point is 6 kHz, correspondingly, the first frequency band may be 20 Hz to 6 kHz. In other embodiments, the first frequency band may also be determined by other means, for example, the first frequency band may be preset.

In some embodiments, to enable the first speaker 220 to primarily produce low-frequency or mid-low-frequency sound, frequency division processing may be performed by hardware. For example, a low-pass filter may be configured to perform low-pass filtering on an audio signal input to the acoustic output device 200 to generate a first signal containing first frequency band information components below the crossover frequency point. Typically, if a low-pass filter with a lower order is selected, the signal roll-off rate is smaller, and it may not be guaranteed that the sound pressure level in the frequency band after the crossover frequency point is significantly reduced. The first speaker 220 may still produce more high-frequency sound, and sound leakage in the high-frequency range may still occur. However, if a low-pass filter with a higher order is selected, more electronic components are required, which increases impedance and causes a reduction in the sensitivity of the first speaker 220.

In some embodiments, the resonance frequency of the front chamber and/or the rear chamber of the first speaker 220 may be adjusted to a lower frequency band. The rapid attenuation of sound waves at frequencies higher than the chamber resonance frequency of the first speaker 220 is utilized to achieve a “low-pass filtering” effect, thereby reducing the high-frequency sound output by the first speaker 220, thereby reducing far-field sound leakage of the first speaker 220 at high frequencies. In some alternative embodiments, a low-pass filter with a lower order may be used first to perform “preliminary” low-pass filtering on the excitation signal. The preliminarily filtered electrical signal is then transmitted to the first speaker 220. On this basis, “repeated” low-pass filtering may be performed on the sound produced by the first speaker 220, effectively reducing the high-frequency sound output by the first speaker 220, thereby reducing the far-field sound leakage of the first speaker 220 in the high-frequency band.

The resonance frequency of the front chamber of the first speaker 220 may be defined as the first resonance frequency. The resonance frequency of the rear chamber of the first speaker 220 may be defined as the second resonance frequency. Merely by way of example, a test manner for the first resonance frequency may be as follows. A test microphone is placed close to and directly faces the first sound guiding hole coupled to the front chamber. The acoustic output device 200 is excited to test to obtain a frequency response curve of the front chamber. The first resonance frequency is then read from the frequency response curve of the front chamber. Alternatively, the microphone directly faces the second sound guiding hole coupled to the rear chamber, the acoustic output device 200 is excited to test to obtain a frequency response curve of the rear chamber. The second resonance frequency is then read from the frequency response curve of the rear chamber. In this case, a distance between the microphone and the first sound guiding hole or the second sound guiding hole may be less than a preset distance threshold, e.g., less than 5 cm.

In some embodiments, the second speaker 230 is configured to perform frequency division processing on a received excitation signal based on a crossover frequency point, and generate the sound in the second frequency band based on the processed input signal. For ease of understanding, the crossover frequency point may be understood as a cutoff frequency when performing high-pass filtering on the excitation signal.

In some embodiments, the crossover frequency point may be in a frequency range of 6 kHz to 9 kHz. In some embodiments, to avoid missing frequency bands in the sound output by the first speaker 220 and the second speaker 230, the crossover frequency point may be in a frequency range of 6 kHz to 7.5 kHz. For example, the crossover frequency point may be 6.5 kHz. In some embodiments, to increase the frequency band of the sound output by the second speaker 230, the crossover frequency point may be in a frequency range of 7.5 kHz to 8.5 kHz. For example, the crossover frequency point may be 8 kHz.

In this case, sound in the second frequency band may have good directivity in space. By optimizing the positions of the second speaker 230 and the third sound guiding hole 213 on the housing, the sound output by the second speaker 230 can be radiated primarily toward the ear canal direction, thereby reducing sound leakage in the second frequency band. In addition, by setting the crossover frequency point within a higher frequency band, it can be ensured that the sound in the second frequency band, which is primarily played by the second speaker 230, has a higher frequency, thereby avoiding the distortion problem caused by the second speaker 230 playing sound in the low-frequency band.

In some embodiments, to effectively reduce sound leakage produced by the first speaker 220 in a higher frequency band, the higher one of the first resonance frequency and the second resonance frequency may be in a range of 3 kHz to 6 kHz. By limiting the range of the higher one of the first resonance frequency and the second resonance frequency, it can be ensured that sound in the higher frequency band is attenuated through the resonance frequency.

In some embodiments, to avoid superposition and enhancement of shorter-wavelength sound waves emitted from the second sound guiding hole 212 and the first sound guiding hole 211 in space, the higher one of the first resonance frequency and the second resonance frequency may be in a range of 4.5 kHz to 5 kHz. By further limiting the range of the higher one of the first resonance frequency and the second resonance frequency, it can be avoided that the range of the first frequency band played by the first speaker 220 is too narrow, which causes a loss of a portion of a mid-high frequency band, at the same time, the attenuation of sound in the higher frequency band by the resonance frequency may be ensured.

The higher one of the first resonance frequency and the second resonance frequency should not be too far from the aforementioned crossover frequency point. Otherwise, it may result in a missing frequency band in the sound played by the acoustic output device 200. Specifically, the first speaker 220 may attenuate sound at a frequency above the higher one of the first resonance frequency and the second resonance frequency. The second speaker 230 primarily outputs sound at frequencies higher than the crossover frequency point. If the higher one of the first resonance frequency and the second resonance frequency is too far from the crossover frequency point, the acoustic output device 200 may not effectively output sound in the frequency band between the higher one of the first resonance frequency and the second resonance frequency and the crossover frequency point, which results in missing playback frequency bands. Certainly, the higher one of the first resonance frequency and the second resonance frequency should also not be too close to the crossover frequency point. Otherwise, the first speaker 220 may still output more high-frequency sound. In some embodiments, a difference between the higher one of the first resonance frequency and the second resonance frequency and the crossover frequency point may be in a range of 2 kHz to 3.5 kHz. In some embodiments, the difference between the higher one of the first resonance frequency and the second resonance frequency and the crossover frequency point may be in a range of 2.2 kHz to 3.2 kHz. In some embodiments, the difference between the higher one of the first resonance frequency and the second resonance frequency and the crossover frequency point may be in a range of 2.5 kHz to 3 kHz. It should be understood that a larger difference between the higher one of the first resonance frequency and the second resonance frequency and the crossover frequency point indicates that the crossover frequency point is located farther from the higher one of the first resonance frequency and the second resonance frequency. By setting the difference between the higher one of the first resonance frequency and the second resonance frequency and the crossover frequency point, it can be avoided that the higher one of the first resonance frequency and the second resonance frequency is too close to the crossover frequency point, which reduces the interference between the sound output by the first speaker 220 and the second speaker 230, ensuring the full-frequency-band output performance of the acoustic output device 200. Simultaneously, it can be avoided that the higher one of the first resonance frequency and the second resonance frequency is too far from the crossover frequency point, which may result in missing frequency bands between the sound output by the first speaker 220 and the second speaker 230, thereby improving the listening experience of the second speaker 230.

By limiting the difference between the higher one of the first resonance frequency and the second resonance frequency and the crossover frequency point within a suitable range, it can be avoided that the frequency difference between the sound output by the second speaker 230 and the first speaker 220 is too large. This prevents missing frequency bands in the sound played by the acoustic output device 200, and ensures that the first speaker 220 can effectively attenuate the sound in the higher frequency band that is prone to cause sound leakage, thereby ensuring the reduction effect of the sound leakage of the acoustic output device 200.

In some embodiments, the first resonance frequency of the front chamber is higher than the second resonance frequency of the rear chamber. This is because the front chamber of the first speaker 220 in the acoustic output device 200 primarily affects the cutoff frequency of the high-frequency band of the sound played by the first speaker 220. The rear chamber of the first speaker 220 affects the low-frequency peak of the sound played by the first speaker 220. In some embodiments, the first resonance frequency may be in a range of 3 kHz to 6 kHz, and the second resonance frequency may be in a range of 2 kHz to 5 kHz. In some embodiments, the first resonance frequency may be in a range of 3.5 kHz to 5.5 kHz, and the second resonance frequency may be in a range of 3 kHz to 5 kHz. In some embodiments, the first resonance frequency may be in a range of 4 kHz to 5.5 kHz, and the second resonance frequency may be in a range of 3.5 kHz to 5 kHz. In some embodiments, the first resonance frequency may be in a range of 4.5 kHz to 5 kHz, and the second resonance frequency may be in a range of 4 kHz to 4.5 kHz.

Some embodiments below in the present disclosure will provide exemplary descriptions of how to reduce the first resonance frequency of the front chamber. It should be known that, in some cases, the second resonance frequency of the rear chamber of the acoustic output device may also be higher than the first resonance frequency of the front chamber. In this case, the following descriptions regarding reducing the first resonance frequency of the front chamber may also be applicable to adjusting the second resonance frequency of the rear chamber.

FIG. 7 is a schematic diagram illustrating frequency response curves of a front chamber corresponding to different chamber volumes according to some embodiments of the present disclosure. In FIG. 7, a horizontal coordinate represents a response frequency of the front chamber. A vertical coordinate represents a sound pressure level output by the front chamber, i.e., the sound pressure level output by the first sound guiding hole. Curves 71, 72, and 73 correspond to frequency response curves of a front chamber 1, a front chamber 2, and a front chamber 3, respectively. The volumes corresponding to the front chamber 1, the front chamber 2, and the front chamber 3 increase sequentially. As shown in FIG. 7, as the volume of the front chamber increases, resonance frequencies P₁, P₂, and P₃ (i.e., the first resonance frequencies) corresponding to resonance peaks of curves 71, 72, and 73 shift left relative to the horizontal coordinate. That is, as the volume of the front chamber increases, the first resonance frequency of the front chamber decreases. In some embodiments, to make the first resonance frequency in a range of 3 kHz to 6 kHz, the volume of the front chamber is in a range of 150 mm³ to 600 mm3. In some embodiments, the volume of the front chamber is in a range of 250 mm³ to 500 mm3. In some embodiments, the volume of the front chamber is in a range of 300 mm³ to 400 mm³.

Merely by way of example, the volume of the chamber of the first speaker 220 may be obtained in the following manner. A measurement medium is configured to fill a corresponding chamber (e.g., the front chamber or the rear chamber). The medium filling the chamber is then removed. A weight of the medium is measured. A volume of the medium is determined based on the weight and the density of the medium. The volume of the medium is the volume of the corresponding chamber. When a medium with high plasticity is used, the volume of the chamber may be directly measured by utilizing its plasticity. Alternatively, a volume of the medium injected into the chamber may be directly recorded. The aforementioned medium may be a liquid, a non-Newtonian fluid, or the like, to ensure a filling effect for the chamber. For example, the medium may be water.

In some embodiments of the present disclosure, the first resonance frequency may be adjusted by limiting the volume of the front chamber 240. On one hand, the volume of the front chamber 240 should not be too small (e.g., not less than 150 mm³). Otherwise, the first resonance frequency is too high, making it difficult to reduce high-frequency sound output by the first speaker 220, thereby causing sound leakage of the first speaker 220 at higher frequencies in the far field. On the other hand, the volume of the front chamber 240 should not be too large (e.g., not greater than 600 mm3). Otherwise, the first resonance frequency is too low, thereby resulting in a missing frequency band of the sound output by the acoustic output device and increasing a design difficulty of the first sound guiding hole 211. Furthermore, it may cause the housing 210 to be too large, which is inconvenient for a user to wear and affects a wearing experience of the user.

In some embodiments, the first resonance frequency may be adjusted by adjusting the volume of the front chamber 240, thereby causing sound at frequencies higher than the first resonance frequency output by the first speaker 220 to attenuate rapidly, so that the sound at frequencies higher than the first resonance frequency by 1.0 kHz to 1.5 kHz attenuates by no less than 8 dB compared to sound at the first resonance frequency. For example, a sound pressure level when the first speaker 220 plays a sound at a frequency 1.0 kHz higher than the first resonance frequency is 10 dB lower than a sound pressure level when the first speaker 220 plays a sound at the first resonance frequency.

In some embodiments, when a difference between the first resonance frequency and the crossover frequency point is in a range of 2 kHz to 3.5 kHz, sound output by the first speaker 220 at the crossover frequency point may attenuate by no less than 15 dB compared to the sound output by the first speaker 220 at the first resonance frequency.

In some embodiments, a combination of the front chamber 240 of the first speaker 220 and the first sound guiding hole 211 may be regarded as a Helmholtz resonator model. The first sound guiding hole 211 may serve as the neck of the Helmholtz resonator model. The front chamber 240 of the first speaker 220 may serve as the chamber of the Helmholtz resonator model. A resonance frequency of the Helmholtz resonator model is the resonance frequency of the front chamber. In the Helmholtz resonator model, a dimension of the neck (i.e., the first sound guiding hole 211) may affect the resonance frequency f of the front chamber, as shown in the formula (1):

$$f = \frac{c}{2 π} \sqrt{\frac{S}{VL}} , \qquad ( 1 )$$

where c represents a speed of sound, S represents an area of the neck (i.e., the first sound guiding hole 211), V represents a volume of the chamber (i.e., the front chamber 240), and L represents a depth of the neck (i.e., the first sound guiding hole 211).

As may be seen from formula (1), when an area of the first sound guiding hole 211 is increased while other conditions remain unchanged, the first resonance frequency increases. When the area of the first sound guiding hole 211 is decreased, the first resonance frequency decreases accordingly.

In the present disclosure, for ease of description, an area of a sound guiding hole (e.g., the first sound guiding hole 211, the second sound guiding hole 212, or the third sound guiding hole 213) may refer to an area of an outer opening of the sound guiding hole. It should be noted that, in some other embodiments, the area of the sound guiding hole may also refer to an area of another cross-section of the sound guiding hole. For example, the area may refer to an area of an inner opening of the sound guiding hole, an average value of the area of the inner opening and the area of the outer opening, etc.

In some embodiments, to cause the first resonance frequency to fall within a range described elsewhere in the present disclosure, the area of the first sound guiding hole 211 may be in a range of 10 mm² to 62.5 mm². In some embodiments, the area of the first sound guiding hole 211 may be in a range of 20 mm² to 45 mm². In some embodiments, the area of the first sound guiding hole 211 be in a range of 30 mm² to 40 mm².

In some embodiments of the present disclosure, by limiting the area of the first sound guiding hole 211, the first resonance frequency may be limited to reduce sound leakage of the first speaker 220. On the other hand, an excessively large area of the first sound guiding hole 211 is avoided. The excessively large area may occupy too much area on a surface of the housing 210, causing the structure of the acoustic output device 200 to be insufficiently stable and radiated sound energy to be unconcentrated. It is worth noting that the unconcentrated radiated sound energy may cause more sound energy to radiate to the outside, resulting in increased sound leakage, and less sound energy to radiate to the ear canal, resulting in a reduced listening volume. An excessively small area of the first sound guiding hole 211 is also avoided to ensure an air permeability and a sound pressure level of the acoustic output device 200.

In some embodiments, to ensure a listening effect, the first sound guiding hole 211 may be disposed on the inner side surface IS of the acoustic output device 200. A ratio of the area of the first sound guiding hole 211 to an area of the inner side surface IS of the housing 210 may be in a range of 0.03 to 0.20. In some embodiments, the ratio of the area of the first sound guiding hole 211 to the area of the inner side surface IS of the housing 210 may be in a range of 0.05 to 0.15. In some embodiments, the ratio of the area of the first sound guiding hole 211 to the area of the inner side surface IS of the housing 210 may be in a range of 0.08 to 0.12. It may be understood that since dimensions of the ears of the user do not differ greatly, the area of the inner side surface IS of the housing 210 also changes little accordingly. Using the area of the inner side surface IS as a reference, when the first sound guiding hole 211 is disposed on the inner side surface IS facing the ear of the user, an excessively small ratio of the area of the first sound guiding hole to the area of the inner side surface IS indicates that the area of the inner side surface IS is too large and/or the area of the first sound guiding hole 211 is too small, which may reduce the wearing comfort of the user and may also reduce a sound pressure level across the fully-frequency band, affecting the output effect of the first speaker 220. An excessively large ratio of the area of the first sound guiding hole to the area of the inner side surface IS indicates that the area of the inner side surface IS is too small and/or the area of the first sound guiding hole 211 is too large, which may affect the wearing stability of the acoustic output device 200. Meanwhile, the first resonance frequency may also fail to drop to a suitable frequency band (e.g., 3 kHz to 6 kHz). The first speaker 220 may still have a problem of sound leakage at higher frequencies.

FIG. 8 is a schematic diagram illustrating an exemplary inner side surface of a housing according to some embodiments of the present disclosure.

As shown in FIG. 8, the first sound guiding hole 211 and the third sound guiding hole 213 are disposed on the inner side surface IS of the housing.

As described above, the third sound guiding hole 213 is acoustically coupled to the second speaker 230 and outputs sound in the second frequency band, i.e., high-frequency sound or mid-to-high-frequency sound. The high-frequency sound has sharp directivity. To make the sound in the second frequency band more easily received by the human ear, the third sound guiding hole 213 needs to point to the entrance of the ear canal of the human ear. In some embodiments, the third sound guiding hole 213 is disposed in a region near the ear canal on the inner side surface IS. The second speaker 230 acoustically connected to the third sound guiding hole 213 may also be correspondingly disposed in the region near the ear canal on the inner side surface IS. In some embodiments, the second speaker 230 shown in FIG. 4 may be located near a center position on the inner side surface IS. For example, the second speaker 230 may be located in a region between the center position of the inner side surface IS and the free end FE of the housing. The inner side surface IS refers to a side surface of the housing facing the ear of the user when the acoustic output device 200 is worn.

In some embodiments, to make sound in the first frequency band more easily received by the human ear, the first sound guiding hole 211 is also disposed facing the ear canal.

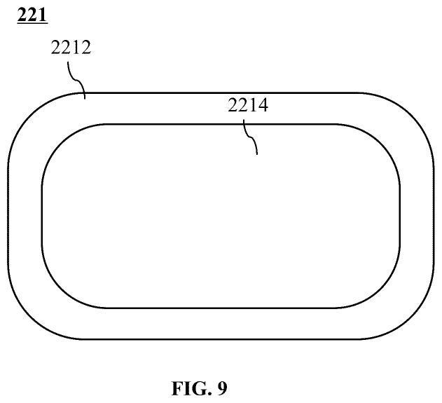

In some embodiments, the position of the first sound guiding hole 211 on the inner side surface IS affects an internal sound pressure distribution of the first speaker 220, thereby affecting the first resonance frequency. As shown in FIG. 9, the first diaphragm 221 includes a surround portion 2212 and a dome portion 2214. The surround portion 2212 mainly affects output of low-frequency sound. The dome portion 2214 mainly affects output of high-frequency sound. When the user wears the acoustic output device 200, the surround portion 2212 is close to the ear canal of the user. By disposing the first sound guiding hole 211 within a region corresponding to the surround portion 2212, the first sound guiding hole 211 may directly face the ear canal to ensure that sound output from the first sound guiding hole 211 is better received by the user. When the first diaphragm 221 is disposed in the housing, the surround portion 2212 is mainly located at a position near an edge of the inner side surface IS. Therefore, the first sound guiding hole 211 may be disposed in a region away from the center of the inner side surface IS, thereby ensuring the output of the low-frequency sound of the first speaker. In some embodiments, the first sound guiding hole 211 is disposed in an edge region on the inner side surface IS. For example, the first sound guiding hole 211 may be disposed in a region on the inner side surface IS near the upper side surface US, the lower side surface LS, or the free end FE.

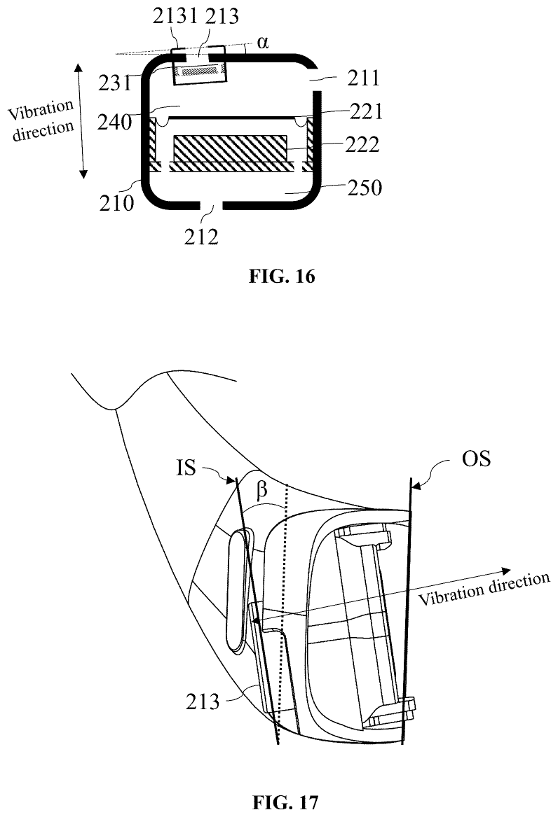

In some embodiments, the first sound guiding hole 211 at least partially surrounds the third sound guiding hole 213. For example, the first speaker 220 and the second speaker 230 may share a chamber. That is, the second speaker 230 may be disposed in the front chamber of the first speaker 220. The first sound guiding hole 211 at least partially surrounds the third sound guiding hole 213. As another example, the first speaker 220 and the second speaker 230 may not share a chamber. That is, the second speaker 230 may be disposed outside the front chamber of the first speaker 220. For example, as shown in FIG. 16, the second speaker 230 may be disposed in a separate chamber. In this case, the first sound guiding hole 211 at least partially surrounds the second speaker 230 and the third sound guiding hole 213 on the second speaker 230.

In some embodiments of the present disclosure, the first sound guiding hole 211 may at least partially surround the third sound guiding hole 213. That is, the first speaker 220 and the second speaker 230 do not share a sound guiding hole. Such an arrangement may simplify a structure outside the second speaker 230 (e.g., reduce a thickness of the housing 210). This is because, typically, the second speaker 230 is a packaged structure. The entire second speaker 230 is placed in the front chamber of the first speaker 220. If the first speaker 220 and the second speaker 230 need to share a sound guiding hole, it is equivalent to disposing the first sound guiding hole 211 outside the second sound guiding hole 212 (both speakers need to radiate sound outward through the first sound guiding hole 211, the first sound guiding hole 211 is the shared sound guiding hole). Compared to a manner where the first sound guiding hole 211 and the second sound guiding hole 212 are staggered on the inner side surface IS of the housing 210 when not sharing a sound guiding hole, sharing a sound guiding hole causes an overall dimension (especially the thickness of the housing 210) of the acoustic output device 200 to be larger.

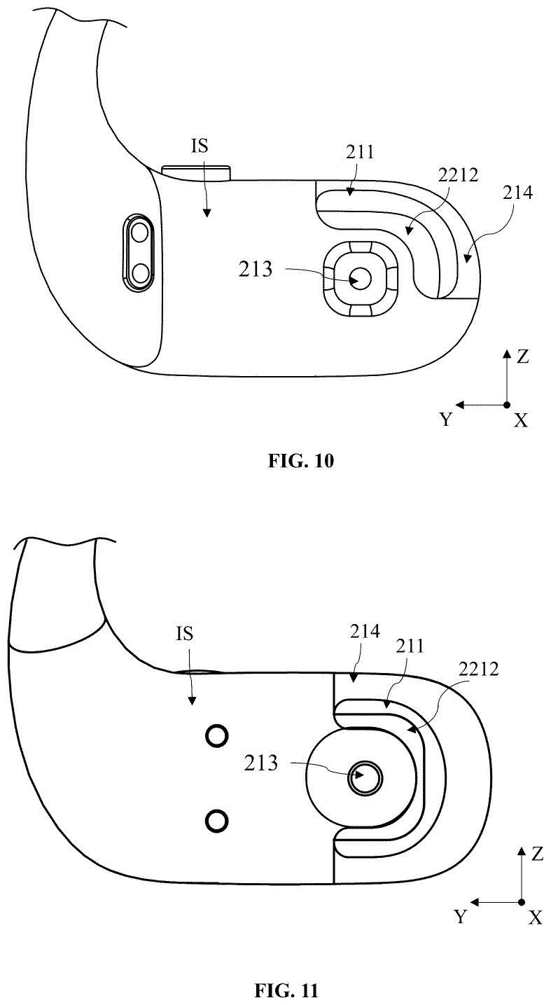

Referring to FIG. 8, in some embodiments, the first sound guiding hole 211 may be L-shaped. The third sound guiding hole 213 may be disposed on the inner side of the L-shaped first sound guiding hole 211. The first sound guiding hole 211 partially surrounds the third sound guiding hole 213. The L-shaped first sound guiding hole 211 may be formed by an intersection of two regions. The inner side of the L-shaped first sound guiding hole 211 refers to a side of the two intersecting regions that is closer to the center position of the inner side surface IS. The manner in which the first sound guiding hole 211 at least partially surrounds the third sound guiding hole 213 is not limited to the manner shown in FIG. 8. The L-shaped first sound guiding hole 211 may also be arranged at other positions on the inner side surface IS after rotation and/or flipping. As an example, the L-shaped first sound guiding hole 211 may also be arranged as shown in FIG. 10.

In other embodiments, the first sound guiding hole 211 is arc-shaped. The third sound guiding hole 213 is arranged on an inner side of the arc-shaped first sound guiding hole 211. The arc-shaped first sound guiding hole 211 may partially surround a side of the second speaker 230 close to the first sound guiding hole 211.

As shown in FIG. 11, in other embodiments, the first sound guiding hole 211 may be U-shaped. The third sound guiding hole 213 is arranged on an inner side of the U-shaped first sound guiding hole 211. The U-shaped first sound guiding hole 211 may surround a side of the second speaker 230 close to the first sound guiding hole 211. The inner side of the U-shaped first sound guiding hole 211 refers to a region enclosed by two inwardly curved arms forming the U shape.

In some embodiments of the present disclosure, configuring the first sound guiding hole 211 as L-shaped or U-shaped allows the first sound guiding hole 211 to extend along the edge region on the inner side surface IS, positioning the first sound guiding hole 211 away from the center position of the inner side surface IS, thereby reducing the first resonance frequency.

In some embodiments, an outer side 2111 of the first sound guiding hole 211 may extend to the junction surface JS between the inner side surface IS and at least one of the rear side surface BS, the upper side surface US, and the lower side surface LS of the housing 210. For more description regarding the upper side surface US and the lower side surface LS, refer to the preceding description of the present disclosure. As shown in FIG. 12, in some embodiments, the junction surface JS between the inner side surface IS and at least one of the rear side surface BS, the upper side surface US, and the lower side surface LS of the housing 210 is an arc surface with a smooth transition.

As shown in FIG. 12, the outer side 2111 of the first sound guiding hole 211 extends to the junction surface JS between the inner side surface IS and the rear side surface BS and the lower side surface LS. In this case, the outer side of the first sound guiding hole 211 is a side of an outer opening of the first sound guiding hole 211 away from the second speaker 230. It is understandable that when the first sound guiding hole 211 is arranged only on the inner side surface IS, if the outer opening of the first sound guiding hole 211 exists in the long axis direction Y and the short axis direction Z, an end surface of the outer opening coincides with the inner side surface IS. If the outer side 2111 of the first sound guiding hole 211 extends to the junction surface JS between the inner side surface IS and another side surface, and the outer opening of the first sound guiding hole 211 extends in the thickness direction X, an outer end surface M and an inner end surface N of the first sound guiding hole 211 are formed along the thickness direction X. The outer end surface M is an end surface of the outer opening of the first sound guiding hole 211 close to the ear in the wearing state. The inner end surface N is an end surface of the outer opening of the first sound guiding hole 211 away from the ear in the wearing state.

As shown in FIG. 12, when the outer side 2111 of the first sound guiding hole 211 extends to the junction surface JS between the inner side surface IS and the rear side surface BS and the lower side surface LS, the first sound guiding hole 211 extends in the thickness direction X. In this case, the outer opening of the first sound guiding hole 211 has the outer end surface M and the inner end surface N.

In some embodiments, the inner end surface N may extend to an inner opening of the first sound guiding hole 211, and connect the outer opening and the inner opening of the first sound guiding hole 211.

In some embodiments, the outer side 2111 of the first sound guiding hole 211 may extend to a junction surface between the inner side surface IS and any one of the rear side surface, the upper side surface US, and the lower side surface LS. In some embodiments, the first sound guiding hole 211 is arranged on the inner side surface IS close to the free end FE. The outer side 2111 of the first sound guiding hole 211 extends to junction surfaces between the inner side surface IS and at least two of the rear side surface, the upper side surface US, and the lower side surface LS. Merely by way of example, when the first sound guiding hole 211 is L-shaped, as shown at the position of the first sound guiding hole 211 in FIG. 8, the outer side 2111 of the first sound guiding hole 211 extends to junction surfaces between the inner side surface IS and the rear side surface and the lower side surface LS. In some embodiments, the outer side 2111 of the first sound guiding hole 211 extends to junction surfaces between the inner side surface IS and at least three of the rear side surface, the upper side surface US, and the lower side surface LS. Merely by way of example, as shown in FIG. 11, when the first sound guiding hole 211 is U-shaped, the first sound guiding hole 211 is arranged close to the free end FE. The outer side 2111 of the first sound guiding hole 211 extends to junction surfaces between the inner side surface IS and the rear side surface, the upper side surface US, and the lower side surface LS.

In some embodiments of the present disclosure, the outer side of the first sound guiding hole 211 extends to the junction surface corresponding to at least one of the rear side surface, the upper side surface US, and the lower side surface LS, positioning the first sound guiding hole 211 in a region of the inner side surface IS away from the center, thereby ensuring output of the low-frequency sound of the first speaker.

Continuing with reference to FIG. 8, in some embodiments, because the second speaker 230 occupies a partial surface area of the inner side surface IS, the first sound guiding hole 211 and the second speaker 230 are arranged staggered. A distance between an endpoint 2112 of a lowermost edge of the first sound guiding hole 211 and the lower side surface LS of the housing in the short axis direction Z of the housing may be in a range of 1 mm to 9 mm, ensuring that the first sound guiding hole 211 is located at an edge position of the inner side surface IS (e.g., a lower edge position of the inner side surface IS), thereby reducing the first resonance frequency. In some embodiments, the distance between the endpoint 2112 of the lowermost edge of the first sound guiding hole 211 and the lower side surface LS of the housing in the short axis direction Z of the housing may be in a range of 1.2 mm to 5 mm. In some embodiments, the distance between the endpoint 2112 of the lowermost edge of the first sound guiding hole 211 and the lower side surface LS of the housing in the short axis direction Z of the housing may be in a range of 5.1 mm to 9 mm.

In some embodiments, a distance between an endpoint 2113 of an uppermost edge of the first sound guiding hole 211 and the upper side surface US of the housing in the short axis direction Z of the housing is in a range of 1 mm to 9 mm, ensuring that the first sound guiding hole 211 is located at an edge position of the inner side surface IS (e.g., an upper edge position of the inner side surface IS), thereby reducing the first resonance frequency. In some embodiments, the distance between the endpoint 2113 of the uppermost edge of the first sound guiding hole 211 and the upper side surface US of the housing in the short axis direction Z of the housing is in a range of 1.2 mm to 5 mm. In some embodiments, the distance between the endpoint 2113 of the uppermost edge of the first sound guiding hole 211 and the upper side surface US of the housing in the short axis direction Z of the housing is in a range of 5.1 mm to 9 mm.

In some embodiments, when the first sound guiding hole 211 is L-shaped, the distance from the endpoint 2113 of the uppermost edge of the first sound guiding hole 211 to the upper side surface US or the distance from the endpoint 2112 of the lowermost edge of the first sound guiding hole 211 to the lower side surface LS may be defined, which ensures the first sound guiding hole 211 is located at the edge position of the inner side surface IS, avoiding an excessively high first resonance frequency.

In some embodiments, when the first sound guiding hole 211 is U-shaped, the distance from the endpoint 2113 of the uppermost edge of the first sound guiding hole 211 to the upper side surface US and the distance from the endpoint 2112 of the lowermost edge of the first sound guiding hole 211 to the lower side surface LS may be defined, which ensures the first sound guiding hole 211 is located at the edge position of the inner side surface IS, avoiding the excessively high first resonance frequency.

In some embodiments, a distance between a rightmost endpoint 2114 of the first sound guiding hole 211 and the rear side surface of the housing in the long axis direction Y of the housing is in a range of 1 mm to 4 mm, ensuring that the first sound guiding hole 211 is located at an edge position of the inner side surface IS (e.g., a right edge position of the inner side surface IS), thereby reducing the first resonance frequency.

In some embodiments of the present disclosure, by setting distances between endpoints of the first sound guiding hole 211 and the rear side surface BS, the upper side surface US, and the lower side surface LS of the housing, the first sound guiding hole 211 can be positioned away from the center position of the inner side surface IS, thereby ensuring output of the low-frequency sound of the first speaker.

In some embodiments, a dimension of the first sound guiding hole 211 in the long axis direction Y of the housing may be in a range of 4 mm to 10 mm (e.g., 5 mm to 9 mm, 6 mm to 8 mm, etc.). Limiting the length dimension of the first sound guiding hole 211 helps to ensure the dimension of the area of the first sound guiding hole, reduce the first resonance frequency, and ensure the reduction effect of sound leakage.

In some embodiments, a dimension of the first sound guiding hole 211 in the short axis direction Z of the housing may be in a range of 3 mm to 9 mm (e.g., 4 mm to 8 mm, 5 mm to 7 mm, etc.). Limiting the height dimension of the first sound guiding hole 211 helps to ensure the dimension of the area of the first sound guiding hole, reduce the first resonance frequency, and ensure the reduction effect of sound leakage.

In some embodiments, referring to FIG. 10, a barrier wall 214 may be disposed to the outer side of the first sound guiding hole 211. The barrier wall 214 increases a dimension of the outer side surface of the first sound guiding hole 211 along the thickness direction X in the housing 210. The outer side surface of the first sound guiding hole 211 may refer to a side surface between the outer opening and the inner opening of the first sound guiding hole 211 that is closer to an edge of the housing 210. For example, the outer side surface of the first sound guiding hole 211 shown in FIG. 12 is located on the junction surface JS between the inner side surface IS and the rear side surface BS, and on the junction surface JS between the inner side surface IS and the lower side surface LS.

It is understandable that when the outer side 2111 of the first sound guiding hole 211 extends to the junction surface JS between the inner side surface IS and at least one of the rear side surface, the upper side surface US, and the lower side surface LS, adding the barrier wall 214 to the outer side of the first sound guiding hole 211 can increase the dimension of the outer side surface of the first sound guiding hole 211 along the thickness direction X in the housing 210.

For example, the inner end surface N of the first sound guiding hole 211 shown in FIG. 12 coincides with the inner opening of the first sound guiding hole 211. In this case, the dimension of the outer side surface of the first sound guiding hole 211 in the thickness direction X is 0. By adding the barrier wall 214 to the outer side of the first sound guiding hole 211, the barrier wall 214 may constitute the outer side surface of the first sound guiding hole 211, thereby increasing the dimension of the outer side surface of the first sound guiding hole 211 in the thickness direction X in the housing 210.

As shown in FIG. 13, in some embodiments, the barrier wall 214 connects to an outer side surface of the first sound guiding hole 211 close to the rear side surface BS. The barrier wall 214 also connects to an outer side surface of the first sound guiding hole 211 close to the lower side surface LS. The barrier wall 214 increases the dimension of the outer side surface of the first sound guiding hole 211 along the thickness direction X in the housing 210.

In some embodiments, the barrier wall 214 may extend along the junction surface JS between the inner side surface IS of the housing 210 and the rear side surface BS and the lower side surface LS. A projection of the barrier wall 214 along the thickness direction X is at least partially located on the junction surface JS between the inner side surface IS and the lower side surface LS and the rear side surface BS.

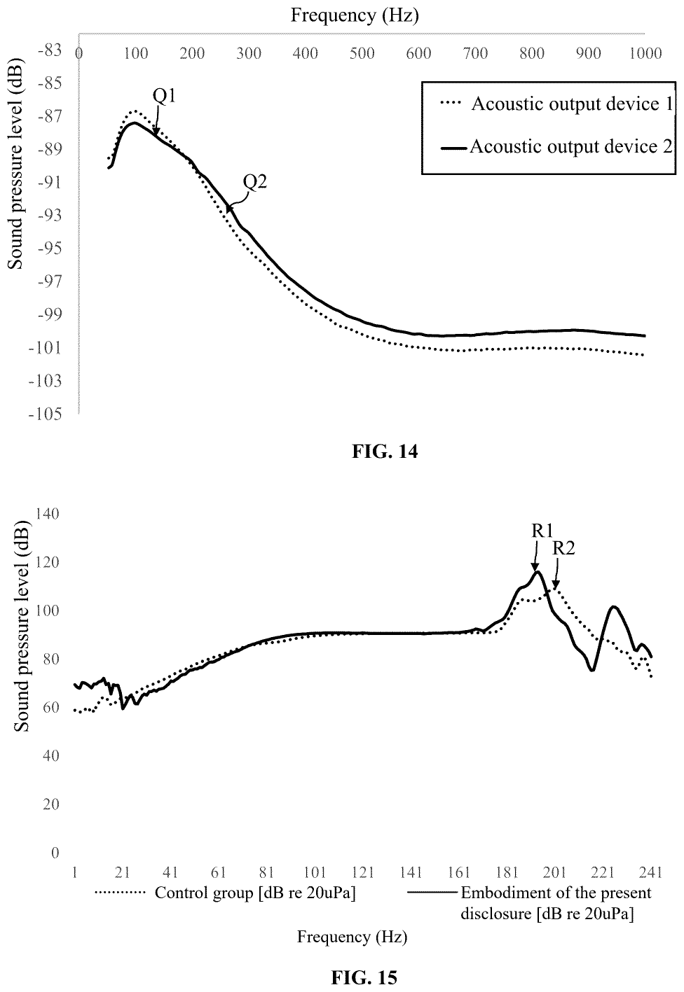

FIG. 14 is a schematic diagram illustrating frequency response curves of two acoustic output devices according to some embodiments of the present disclosure. In FIG. 14, a horizontal coordinate represents a response frequency of a front chamber. A vertical coordinate represents a sound pressure level output by the front chamber, i.e., a sound pressure level output by the first sound guiding hole 211. Curves Q1 and Q2 correspond to frequency response curves of an acoustic output device 1 (e.g., the acoustic output device shown in FIG. 13) and an acoustic output device 2 (e.g., the acoustic output device shown in FIG. 12), respectively. A difference between the aforementioned acoustic output device 1 and acoustic output device 2 is that the acoustic output device 1 is provided with a barrier wall, and the acoustic output device 2 is not provided with a barrier wall. As shown in FIG. 14, in a lower frequency band (e.g., within 0 Hz to 200 Hz), a sound pressure level of curve Q1 is greater than a sound pressure level of curve Q2. Based on this, setting the barrier wall can increase the sound pressure level when the first speaker 220 plays sound in the lower frequency band, ensuring the listening effect for the user in the lower frequency band. Furthermore, in a higher frequency band, the sound pressure level of the acoustic output device provided with the barrier wall is less than the sound pressure level of the acoustic output device not provided with the barrier wall, which can reduce the sound pressure level when the first speaker 220 plays sound in the higher frequency band, reduce a perception of the user of the sound in the higher frequency band played by the first speaker 220, and avoid high-frequency sound leakage of the first sound guiding hole 211.

Furthermore, by arranging the barrier wall on the outer side of the first sound guiding hole 211, while reducing an opening area of the first sound guiding hole 211, an air output of the front chamber is not excessively affected, ensuring an overall sound pressure level when the first sound guiding hole 211 outputs sound.

In some embodiments, referring to FIG. 8, a protruding portion 215 is provided on the inner side surface IS of the acoustic output device 200 along the thickness direction X of the housing 210. The protruding portion 215 protrudes from the inner side surface IS in a direction away from the housing 210. In some embodiments, a cross-sectional shape of the protruding portion 215 includes, but is not limited to, a square with rounded corners as shown in FIG. 8, a circle, a square, a triangle, etc. In some embodiments, the protruding portion 215 may be integrally formed with the housing 210, or may be provided separately from the housing 210. In some embodiments, the protruding portion 215 may be a portion of the housing that forms the second speaker 230. At least a portion of the second speaker 230 is disposed within the protruding portion 215. In some embodiments, the third sound guiding hole 213 may be disposed on the protruding portion 215 and penetrate through the protruding portion 215. The third sound guiding hole 213 is acoustically connected to the front chamber of the second speaker 230 to output sound generated by the second speaker 230. The provision of the protruding portion 215 may reduce a distance from the second speaker 220 to the ear canal, thereby improving sound quality received by the user. In some embodiments, to enable the third sound guiding hole 213 and the first sound guiding hole 211 to be simultaneously closer to the ear canal of the user, to ensure that the third sound guiding hole 213 and the first sound guiding hole 211 can simultaneously point towards the ear canal, and to ensure full-frequency output of the acoustic output device 200, the protruding portion 215 is disposed adjacent to the first sound guiding hole 211. At least a portion of an outer side wall of the protruding portion 215 defines an inner edge of the first sound guiding hole 211. The at least a portion of the outer side wall of the protruding portion 215 is a side wall where the protruding portion 215 connects to the inner side surface IS, which is perpendicular or approximately perpendicular to a YZ plane in FIG. 8. The provision of the protruding portion 215 is equivalent to increasing a local thickness dimension of the inner side surface IS. The first sound guiding hole 211 penetrates through the inner side surface IS and is disposed immediately next to the protruding portion 215. The at least a portion of the outer side wall of the protruding portion 215 forms the inner edge of the first sound guiding hole 211.

By designing the volume of the front chamber of the first speaker and the first sound guiding hole by one or more of the aforementioned arrangements, the first resonance frequency can be located within a required range. Merely by way of example, by increasing the volume of the front chamber, adjusting the area of the first sound guiding hole, and positioning the first sound guiding hole away from the center position of the acoustic output device, a frequency response curve R1 as shown in FIG. 15 may be obtained. A frequency response curve R2 corresponds to a front chamber of a conventional speaker (a control group, without design of the volume of the front chamber or the sound guiding hole). In FIG. 15, a horizontal coordinate represents a response frequency of the front chamber, and a vertical coordinate represents a sound pressure level output by the front chamber. As can be seen from FIG. 15, a resonance peak of the adjusted front chamber 240 shifts forward by approximately 1 kHz compared to a resonance peak of the front chamber of the conventional first speaker, this results in a 10 dB reduction in the sound pressure level within the 6k˜10 KHz frequency band (high frequencies), thereby significantly reducing mid-to-high frequency sound output from the first speaker 220, further reducing far-field sound leakage radiated from the second sound guiding hole 212, and improving the listening experience of the user.

High-frequency sound waves have strong directivity and attenuate quickly. When directed towards the ear canal, the high-frequency sound waves can be better received by the human ear. In some embodiments, referring to FIG. 3, when the acoustic output device 200 is worn on the human ear, the ear canal of the human ear may be located obliquely below the housing of the acoustic output device 200. That is, an axis of the entrance of the ear canal has a certain tilt angle relative to the thickness direction X of the housing. To better transmit the high-frequency sound waves to the ear canal, the second speaker and/or the third sound guiding hole may be set to tilt towards a position where the ear canal is located, ensuring that the human ear can more smoothly receive the high-frequency sound waves generated by the second speaker.

FIG. 16 is a schematic diagram illustrating an exemplary structure of an acoustic output device according to some embodiments of the present disclosure.

In some embodiments, in the wearing state, an overall position of the housing of the acoustic output device is higher than the entrance of the ear canal, and the inner side surface IS of the housing does not directly face the entrance of the ear canal. To enable the third sound guiding hole 213 to better point towards the ear canal, a first tilt angle α is formed between an outer opening of the third sound guiding hole 213 (i.e., a plane 2131 where an opening facing the ear is located) and the inner side surface IS of the housing 210 (refer to FIG. 16). In some embodiments, the first tilt angle α may be in a range of 3° to 8°, which may adapt to a height difference between the ear canal and the housing. In some embodiments, the first tilt angle α may be in a range of 5° to 6°, further improving the directivity of the third sound guiding hole 213. In some embodiments, a vibration direction of the second diaphragm 231 (refer to FIG. 16) is perpendicular to the plane 2131 where the outer opening of the third sound guiding hole 213 is located. Sound generated by the second diaphragm 231 may enter the ear canal along a direction of the ear canal. At this time, the first tilt angle α is formed between a vibration direction of the first diaphragm 221 and the vibration direction of the second diaphragm 231.

This approach should be understood as tilting the second speaker 230 relative to the inner side surface IS of the housing, which can enable the third sound guiding hole 213 to better point towards the ear canal, ensuring that the sound in the second frequency band better points towards the entrance of the ear canal.

FIG. 17 is a schematic diagram illustrating another exemplary structure of an acoustic output device according to some embodiments of the present disclosure.

In some embodiments, to adapt to a height difference between the entrance of the ear canal and the housing, the inner side surface IS of the acoustic output device 200 may be disposed in a tilted manner. At this time, a second tilt angle β may be formed between the inner side surface IS and the outer side surface OS of the housing 210 (refer to FIG. 17). In some embodiments, the second tilt angle β may be in a range of 3° to 8°, which can adapt to the height difference between the ear canal and the housing. In some embodiments, the second tilt angle β may be in a range of 5° to 6°, further improving the directivity of the third sound guiding hole 213. In some embodiments, a vibration direction of the second diaphragm 231 (refer to FIG. 17) is parallel to a vibration direction of the first diaphragm 221, and is perpendicular to the inner side surface IS of the acoustic output device 200. Sound generated by the second diaphragm 231 may enter the ear canal along a direction of the ear canal.

This approach should be understood as tilting the inner side surface IS of the second speaker 230, the first speaker 220, and the second speaker 230, which can enable both the first sound guiding hole 211 and the third sound guiding hole 213 to point towards the ear canal, ensuring that sound in the first frequency band and the second frequency band can better point towards the entrance of the ear canal to be better received by the user.

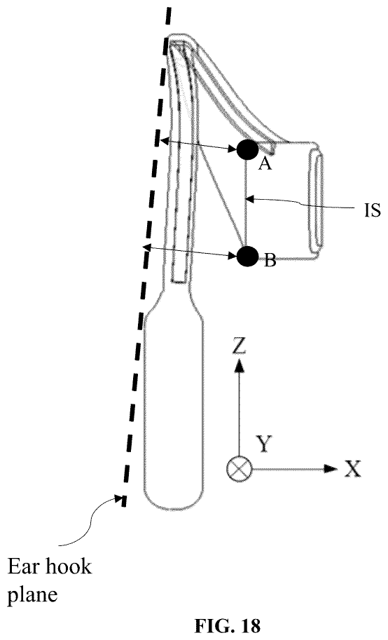

FIG. 18 is a schematic diagram illustrating yet another exemplary structure of an acoustic output device according to some embodiments of the present disclosure.

In some embodiments, as shown in FIG. 18, the support structure 12 includes an ear hook (referring to FIG. 4). To adapt to a height difference between the entrance of the ear canal and the housing, the ear hook may be designed such that the entire housing is disposed in a tilted manner relative to the entrance of the ear canal. Since the ear hook has an irregular shape, for example, the ear hook may be an arc-shaped structure, a plane where the ear hook is located (also referred to as an ear hook plane) may be considered as follows. In a non-wearing state, when the ear hook is placed flat on a plane, the plane is tangent to at least three points on the ear hook, constituting the ear hook plane. In some embodiments, tilting of the entire housing relative to the entrance of the ear canal may be defined in the following manner. Referring to FIG. 18, a first position is a midpoint A of an upper edge of the inner side surface IS, and a second position is a midpoint B of a lower edge of the inner side surface IS. The upper edge of the inner side surface IS is an edge where the inner side surface IS connects to the upper side surface US, and the lower edge of the inner side surface IS is an edge where the inner side surface IS connects to the lower side surface LS. A first distance between the ear hook plane and the first position is less than a second distance between the ear hook plane and the second position. That is, an angle exists between the ear hook plane and a line connecting the first position and the second position. The angle may be in a range of 3° to 8° to adapt to the height difference between the ear canal and the housing. The angle may also be in a range of 5° to 6° to further improve the directivity of the third sound guiding hole 213.

This approach may be understood as tilting the entire housing of the acoustic output device 200 through the support structure, which can enable the third sound guiding hole 213 to better point towards the ear canal, ensuring that sound in the second frequency band better points towards the entrance of the ear canal.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. An acoustic output device, comprising:
a first speaker including a first diaphragm configured to generate sound in a first frequency band;
a second speaker including a second diaphragm configured to generate sound in a second frequency band, wherein the second frequency band includes frequencies higher than an upper limit frequency of the first frequency band;
a housing configured to carry the first speaker and the second speaker; and
a support structure configured to place the housing near an ear canal without blocking an entrance of the ear canal, wherein:
at least two sound guiding holes are disposed on the housing, a first sound guiding hole of the at least two sound guiding holes is acoustically coupled to a front side of the first diaphragm and defines a front chamber of the first speaker, a second sound guiding hole of the at least two sound guiding holes is acoustically coupled to a rear side of the first diaphragm and defines a rear chamber of the first speaker, the front chamber has a first resonance frequency, the rear chamber has a second resonance frequency, and a higher one of the first resonance frequency and the second resonance frequency is in a range of 3 kHz to 6 KHz.

2. The acoustic output device of claim 1, wherein the second speaker is configured to generate the sound in the second frequency band by performing frequency division processing on a received excitation signal based on a crossover frequency point, wherein:
a difference between the higher one of the first resonance frequency and the second resonance frequency and the crossover frequency point is in a range of 2 kHz to 3.5 kHz.

3. The acoustic output device of claim 2, wherein the crossover frequency point is in a frequency range of 6 kHz to 9 kHz.

4. The acoustic output device of claim 1, wherein a volume of the front chamber is in a range of 150 mm3 to 600 mm3; or
an area of the first sound guiding hole is in a range of 10 mm2 to 62.5 mm².

5. The acoustic output device of claim 1, wherein the first sound guiding hole is disposed on an inner side surface of the housing, a ratio of an area of the first sound guiding hole to an area of the inner side surface of the housing is in a range of 0.03 to 0.20, and the inner side surface is a side surface of the housing facing an ear in a wearing state.

6. The acoustic output device of claim 1, wherein the at least two sound guiding holes further include a third sound guiding hole, and the second speaker transmits the sound in the second frequency band to outside of the housing through the third sound guiding hole.

7. The acoustic output device of claim 6, wherein the first sound guiding hole is disposed on an inner side surface of the housing; and
the third sound guiding hole is disposed on a lower side surface of the housing or on a connecting surface between the inner side surface and the lower side surface; wherein:
the inner side surface is a side surface of the housing facing an ear in a wearing state, and the lower side surface is a side surface of the housing facing away from the top of the head of a user along a short axis direction of the housing in the wearing state.

8. The acoustic output device of claim 7, wherein the first sound guiding hole and the third sound guiding hole are disposed on an inner side surface of the housing, and the inner side surface is a side surface of the housing facing an ear in a wearing state.

9. The acoustic output device of claim 8, wherein the first sound guiding hole is arranged to at least partially surround the third sound guiding hole.

10. The acoustic output device of claim 9, wherein the first sound guiding hole is L-shaped, and the third sound guiding hole is located on the inner side of the first sound guiding hole.

11. The acoustic output device of claim 9, wherein a protruding portion is disposed on the inner side surface extending away from the housing along a thickness direction of the housing, at least a portion of the second speaker is disposed within the protruding portion, and the third sound guiding hole is disposed on the protruding portion and penetrates through the protruding portion.

12. The acoustic output device of claim 11, wherein at least a portion of an outer side wall of the protruding portion defines an inner edge of the first sound guiding hole.

13. The acoustic output device of claim 7, wherein an outer edge of the first sound guiding hole extends to a connecting surface between the inner side surface and at least one of a rear side surface, an upper side surface, and the lower side surface of the housing, wherein:
an outer side of the first sound guiding hole is a side away from a center of the inner side surface, the rear side surface is a side surface facing a rear of the ear along a long axis direction of the housing in the wearing state, the upper side surface is a side surface close to the top of the head of the user along the short axis direction of the housing in the wearing state, and the lower side surface is the side surface facing away from the top of the head of the user along the short axis direction of the housing in the wearing state.

14. The acoustic output device of claim 9, wherein an outer side of the first sound guiding hole has a barrier wall; and
the barrier wall increases a dimension of an outer edge wall of the first sound guiding hole along a thickness direction of the housing.

15. The acoustic output device of claim 7, wherein a distance between an endpoint of a lowermost edge of the first sound guiding hole and the lower side surface of the housing in the short axis direction of the housing is in a range of 1 mm to 9 mm; or
a distance between an endpoint of an uppermost edge of the first sound guiding hole and an upper side surface of the housing in the short axis direction of the housing is in a range of 1 mm to 9 mm; or
a distance between a rightmost endpoint of the first sound guiding hole and a rear side surface of the housing in a long axis direction of the housing is in a range of 1 mm to 4 mm.

16. The acoustic output device of claim 6, wherein a vibration direction of the second diaphragm is perpendicular to a plane where an outer opening of the third sound guiding hole is located, a first tilt angle is formed between the plane where the outer opening of the third sound guiding hole is located and the inner side surface of the housing, and the first tilt angle is in a range of 3° to 8°.

17. The acoustic output device of claim 1, wherein a dimension of the first sound guiding hole in a long axis direction of the housing is in a range of 4 mm to 10 mm, or a dimension of the first sound guiding hole in a short axis direction of the housing is in a range of 3 mm to 9 mm.

18. The acoustic output device of claim 1, wherein vibration directions of both the second diaphragm and the first diaphragm are perpendicular to an inner side surface of the housing, a second tilt angle is formed between the inner side surface and an outer side surface of the housing, and the second tilt angle is in a range of 3° to 8°, wherein the inner side surface is a side surface of the housing facing an ear in a wearing state.

19. The acoustic output device of claim 1, wherein vibration directions of both the second diaphragm and the first diaphragm are perpendicular to both an inner side surface and an outer side surface of the housing, the inner side surface is a side surface of the housing facing an ear in a wearing state, the outer side surface is a side surface of the housing facing away from the ear in the wearing state; and
the support structure includes an ear hook, in a non-wearing state, a first distance between an ear hook plane of the ear hook and a first position is less than a second distance between the ear hook plane and a second position; wherein:
the first position is a midpoint of an upper edge of the inner side surface, and the second position is a midpoint of a lower edge of the inner side surface.

20. An acoustic output device, comprising:
a first speaker including a first diaphragm configured to generate sound in a first frequency band;
a second speaker including a second diaphragm configured to generate sound in a second frequency band, wherein the second frequency band includes frequencies higher than an upper limit frequency of the first frequency band;
a housing configured to carry the first speaker and the second speaker; and
a support structure configured to place the housing near an ear canal without blocking an entrance of the ear canal, wherein:
at least two sound guiding holes are disposed on the housing, a first sound guiding hole of the at least two sound guiding holes is acoustically coupled to a front side of the first diaphragm and defines a front chamber of the first speaker, a second sound guiding hole of the at least two sound guiding holes is acoustically coupled to a rear side of the first diaphragm and defines a rear chamber of the first speaker, the front chamber of the first speaker has a first resonance frequency, a volume of the front chamber of the first speaker is configured to perform attenuation on sound output by the first speaker at frequencies higher than the first resonance frequency, and the attenuation causes sound in a range of 1.0 kHz to 1.5 kHz higher than the first resonance frequency to be attenuated by not less than 8 dB compared to sound at the first resonance frequency.
